(19) United States
(12) Patent Application Publication
(10) Pub. No.: US 2026/0253356 A1
(43) Pub. Date: Aug. 27, 2026

(54) COMBINING 3D REPRESENTATIONS AND ASSOCIATED METHODS, SYSTEMS, AND NON-TRANSITORY COMPUTER-READABLE MEDIA

(71) Applicant: CoStar Realty Information, Inc., Arlington, VA (US)

(72) Inventors: David Alan Gausebeck, Sunnyvale, CA (US); Japjit Tulsi, Sunnyvale, CA (US); Kirk Stromberg, Sunnyvale, CA (US); Haakon Erichsen, Sunnyvale, CA (US); Olaf Brandt, Sunnyvale, CA (US)

(73) Assignee: CoStar Realty Information, Inc., Arlington, CA (US)

(21) Appl. No.: 19/548,712

(22) Filed: Feb. 24, 2026

Related U.S. Application Data
(60) Provisional application No. 63/763,219, filed on Feb. 25, 2025.

(51) Int. Cl. G06T 19/20; G06F 3/04842; G06T 15/04

(52) U.S. Cl. CPC G06T 19/20; G06F 3/04842; G06T 15/04

(57) ABSTRACT

A 3D representation system that enables users to seamlessly merge multiple 3D representations, including those generated from separate scan jobs, team-capture sessions, or split mobile captures, into a unified 3D representation. Using an interactive interface, users may position, align, or merge numerous 3D representations, such as those for large or complex environments, such as multi-building sites or indoor-outdoor combinations. The 3D representation system may align 3D representations using a common coordinate system. The 3D representation system may also update existing 3D representations by integrating newly captured partial scans, automatically aligning updated data and preserving annotations across versions. The 3D representation system may group 3D representations for unified exploration and provide cross-representation navigation pathways for seamless transitions between related 3D representations. The 3D representation system supports time-based navigation, comparisons, and configuration-specific views, enabling efficient creation, maintenance, and exploration of complex collections of 3D representations.

### CROSS-REFERENCE TO RELATED APPLICATION

This application claims priority to and seeks the benefit of U.S. Provisional Patent Application No. 63/763,219, filed on Feb. 25, 2025, and entitled “SYSTEMS AND METHODS FOR MERGING DIGITAL TWINS,” which is incorporated in its entirety herein by reference.

### TECHNICAL FIELD

The present disclosure relates in general to representations of real-world environments, and in particular to merging or aligning three-dimensional and other representations of real-world environments and data associated with such representations.

### BACKGROUND

Three-dimensional (3D) models of real-world environments are commonly generated from images, depth data, or other sensor inputs captured by mobile devices or 3D cameras. Conventional workflows typically treat each capture session as producing a stand-alone digital artifact, with limited or no native support for combining multiple 3D models, updating only portions of an existing 3D model, or navigating across related 3D models within a consistent spatial reference. In practice, users who wish to assemble large or complex environments, such as multi-floor buildings captured in sections, multi-building sites captured over time, or environments scanned collaboratively by multiple contributors, often rely on manual post-processing, which can be slow, error-prone, and difficult to maintain.

Existing solutions further lack mechanisms for aligning independently captured 3D models to a stable coordinate frame, merging overlapping or complementary portions into a single coherent result, and preserving or transferring annotations, metadata, or other attached information across versions. When partial updates are needed, for example, to reflect renovations, seasonal changes, or corrections, users may be forced to duplicate 3D models, delete outdated regions, and attempt manual realignment, with no guarantees that coordinate frames remain consistent across revisions. Likewise, users who manage multiple related but physically separated portions of an environment (for example, distinct apartments in a complex or separate buildings on a campus) often cannot organize or explore those 3D models as a cohesive collection with unified navigation or side-by-side comparison tools. These limitations impede timely, accurate, and scalable creation and maintenance of integrated 3D models.

### SUMMARY

In some aspects, the techniques described herein relate to a method performed by one or more computing systems that include one or more processors and memory, the method including: receiving a selection of a first 3D representation, the first 3D representation of a first portion of an environment; receiving a selection of a second 3D representation, the second 3D representation of a second portion of the environment; displaying at least some of the first 3D representation and at least some of the second 3D representation; receiving one or more inputs to move the first 3D representation or the second 3D representation; moving, based on the one or more inputs, the first 3D representation or the second 3D representation; receiving a request to combine the first 3D representation and the second 3D representation; and providing the request to combine the first 3D representation and the second 3D representation, wherein, based on the request, the first 3D representation and the second 3D representation are combined.

In some aspects, the techniques described herein relate to a method wherein the request to combine the first 3D representation and the second 3D representation includes a request to merge the first 3D representation and the second 3D representation, and wherein a third 3D representation is generated from merging the first 3D representation and the second 3D representation, the third 3D representation of a third portion of the environment.

In some aspects, the techniques described herein relate to a method wherein the first 3D representation includes a first portion and a second portion, the third 3D representation is generated from the first portion and at least substantially all of the second 3D representation that replaces at least substantially all of the second portion.

In some aspects, the techniques described herein relate to a method wherein the first 3D representation includes a first portion and a second portion, the second 3D representation includes a third portion and a fourth portion, and the third 3D representation is generated from the first portion, the third portion, and the second portion or the fourth portion.

In some aspects, the techniques described herein relate to a method wherein there is substantially no overlap between the first 3D representation and the second 3D representation.

In some aspects, the techniques described herein relate to a method, further including: receiving a request to lock a first position of the first 3D representation and a second position of the second 3D representation; and providing the request to lock the first position and the second position, wherein, based on the request, the first 3D representation and the second 3D representation are not moved relative to each other.

In some aspects, the techniques described herein relate to a method wherein the first 3D representation and the second 3D representation are aligned, the request to combine the first 3D representation and the second 3D representation includes a request to group the first 3D representation and the second 3D representation, and based on the request, the first 3D representation and the second 3D representation are grouped.

In some aspects, the techniques described herein relate to a method, further including: receiving a request to align the first 3D representation and the second 3D representation; and providing the request to align the first 3D representation and the second 3D representation; wherein, based on the request, the first 3D representation and the second 3D representation are aligned.

In some aspects, the techniques described herein relate to a method wherein the first 3D representation and the second 3D representation are aligned to a common coordinate system.

In some aspects, the techniques described herein relate to a method wherein receiving the one or more inputs to move the first 3D representation or the second 3D representation includes: receiving a selection of a first surface of the first 3D representation; and receiving a selection of a second surface of the second 3D representation, wherein moving the first 3D representation or the second 3D representation includes moving, based on the first surface and the second surface, the first 3D representation or the second 3D representation.

In some aspects, the techniques described herein relate to a method wherein each of the first surface and the second surface includes a wall surface or each of the first surface and the second surface includes a floor surface.

In some aspects, the techniques described herein relate to a method wherein a third 3D representation is generated from merging the first 3D representation and the second 3D representation, the third 3D representation of a third portion of the environment, and further including: receiving a request to associate first annotations of the first 3D representation or second annotations of the second 3D representation with the third 3D representation; and providing the request to associate the first annotations or the second annotations with the third 3D representation, wherein, based on the request, at least some of the first annotations or at least some of the second annotations are associated with the third 3D representation.

In some aspects, the techniques described herein relate to a method, further including: receiving a request to color the first 3D representation and the second 3D representation; assigning, based on the request, a first color to the first 3D representation and a second color to the second 3D representation; and displaying at least some of the first 3D representation colored according to the first color and at least some of the second 3D representation colored according to the second color.

In some aspects, the techniques described herein relate to a method wherein the first 3D representation is generated from a first set of data captured by a first device in a first capture session and the second 3D representation is generated from a second set of data captured by a second device in a second capture session, the first device different from the second device or the first capture session different from the second capture session.

In some aspects, the techniques described herein relate to a non-transitory computer-readable medium including executable instructions, the executable instructions being executable by one or more processors to perform a method, the method including: receiving a selection of a first 3D representation, the first 3D representation of a first portion of an environment; receiving a selection of a second 3D representation, the second 3D representation of a second portion of the environment; displaying at least some of the first 3D representation and at least some of the second 3D representation; receiving one or more inputs to move the first 3D representation or the second 3D representation; moving, based on the one or more inputs, the first 3D representation or the second 3D representation; receiving a request to combine the first 3D representation and the second 3D representation; and providing the request to combine the first 3D representation and the second 3D representation, wherein, based on the request, the first 3D representation and the second 3D representation are combined.

In some aspects, the techniques described herein relate to a non-transitory computer-readable medium wherein the request to combine the first 3D representation and the second 3D representation includes a request to merge the first 3D representation and the second 3D representation, and wherein a third 3D representation is generated from merging the first 3D representation and the second 3D representation, the third 3D representation of a third portion of the environment.

In some aspects, the techniques described herein relate to a non-transitory computer-readable medium wherein the first 3D representation includes a first portion and a second portion, the third 3D representation is generated from the first portion and at least substantially all of the second 3D representation that replaces at least substantially all of the second portion.

In some aspects, the techniques described herein relate to a non-transitory computer-readable medium wherein the first 3D representation includes a first portion and a second portion, the second 3D representation includes a third portion and a fourth portion, and the third 3D representation is generated from the first portion, the third portion, and at least substantially all of the fourth portion that replaces at least substantially all of the second portion.

In some aspects, the techniques described herein relate to a non-transitory computer-readable medium wherein there is substantially no overlap between the first 3D representation and the second 3D representation.

In some aspects, the techniques described herein relate to a non-transitory computer-readable medium, the method further including: receiving a request to lock a first position of the first 3D representation and a second position of the second 3D representation; and providing the request to lock the first position and the second position, wherein, based on the request, the first 3D representation and the second 3D representation are not moved relative to each other.

In some aspects, the techniques described herein relate to a non-transitory computer-readable medium wherein the first 3D representation and the second 3D representation are aligned, the request to combine the first 3D representation and the second 3D representation is a request to group the first 3D representation and the second 3D representation, and based on the request, the first 3D representation and the second 3D representation are grouped.

In some aspects, the techniques described herein relate to a non-transitory computer-readable medium, further including: receiving a request to align the first 3D representation and the second 3D representation; and providing the request to align the first 3D representation and the second 3D representation; wherein, based on the request, the first 3D representation and the second 3D representation are aligned.

In some aspects, the techniques described herein relate to a non-transitory computer-readable medium wherein the first 3D representation and the second 3D representation are aligned to a common coordinate system.

In some aspects, the techniques described herein relate to a non-transitory computer-readable medium wherein receiving the one or more inputs to move the first 3D representation or the second 3D representation includes: receiving a selection of a first surface of the first 3D representation; and receiving a selection of a second surface of the second 3D representation, wherein moving the first 3D representation or the second 3D representation includes moving, based on the first surface and the second surface, the first 3D representation or the second 3D representation.

In some aspects, the techniques described herein relate to a non-transitory computer-readable medium wherein each of the first surface and the second surface includes a wall surface or each of the first surface and the second surface includes a floor surface.

In some aspects, the techniques described herein relate to a non-transitory computer-readable medium wherein a third 3D representation is generated from merging the first 3D representation and the second 3D representation, the third 3D representation of a third portion of the environment, and the method further including: receiving a request to associate first annotations of the first 3D representation or second annotations of the second 3D representation with the third 3D representation; and providing the request to associate the first annotations or the second annotations with the third 3D representation, wherein, based on the request, at least some of the first annotations or at least some of the second annotations are associated with the third 3D representation.

In some aspects, the techniques described herein relate to a non-transitory computer-readable medium, the method further including: receiving a request to color the first 3D representation and the second 3D representation; assigning, based on the request, a first color to the first 3D representation and a second color to the second 3D representation; and displaying at least some of the first 3D representation colored according to the first color and at least some of the second 3D representation colored according to the second color.

In some aspects, the techniques described herein relate to a non-transitory computer-readable medium wherein the first 3D representation is generated from a first set of data captured by a first device in a first capture session and the second 3D representation is generated from a second set of data captured by a second device in a second capture session, the first device different from the second device or the first capture session different from the second capture session.

In some aspects, the techniques described herein relate to a system including at least one processor and at least one memory including executable instructions that, when executed by the at least one processor, cause the system to: receive a selection of a first 3D representation, the first 3D representation of a first portion of an environment; receive a selection of a second 3D representation, the second 3D representation of a second portion of the environment; display at least some of the first 3D representation and at least some of the second 3D representation; receive one or more inputs to move the first 3D representation or the second 3D representation; move, based on the one or more inputs, the first 3D representation or the second 3D representation; receive a request to combine the first 3D representation and the second 3D representation; and provide the request to combine the first 3D representation and the second 3D representation, wherein, based on the request, the first 3D representation and the second 3D representation are combined.

In some aspects, the techniques described herein relate to a method performed by one or more computing systems that include one or more processors and memory, the method including: receiving a first 3D representation of a first portion of an environment; receiving a second 3D representation of a second portion of the environment, the first 3D representation and the second 3D representation being aligned to a common coordinate system based on a request to align the first 3D representation and the second 3D representation, the first 3D representation and the second 3D representation being grouped based on a request to combine the first 3D representation and the second 3D representation; displaying at least some of the first 3D representation in a first viewport; displaying at least some of the second 3D representation in a second viewport; receiving one or more inputs to navigate the first 3D representation; moving, based on the one or more inputs, a first virtual camera in the first 3D representation; and moving, based on the one or more inputs, a second virtual camera in the second 3D representation.

In some aspects, the techniques described herein relate to a method wherein the first virtual camera is substantially synchronized with the second virtual camera.

In some aspects, the techniques described herein relate to a method, further including: receiving a request to disable synchronization of the first virtual camera with the second virtual camera; and disabling, based on the request, synchronization of the first virtual camera with the second virtual camera, wherein the first virtual camera is no longer synchronized with the second virtual camera.

In some aspects, the techniques described herein relate to a method wherein the first viewport and the second viewport are adjacent.

In some aspects, the techniques described herein relate to a method wherein the first viewport and the second viewport provide a side-by-side view of the first 3D representation and the second 3D representation.

In some aspects, the techniques described herein relate to a method wherein the first viewport and the second viewport provide a split view of the first 3D representation and the second 3D representation.

In some aspects, the techniques described herein relate to a method wherein the second viewport is overlaid on the first viewport.

In some aspects, the techniques described herein relate to a method wherein displaying at least some of the second 3D representation in the second viewport includes displaying a second portion of the second 3D representation in the second viewport in place of a corresponding first portion of the first 3D representation.

In some aspects, the techniques described herein relate to a method wherein the one or more inputs are one or more first inputs, and further including: receiving one or more second inputs to resize or reposition the second viewport; and resizing or repositioning, based on the one or more second inputs, the second viewport.

In some aspects, the techniques described herein relate to a method wherein the second 3D representation includes a redesign of the first portion of the environment.

In some aspects, the techniques described herein relate to a non-transitory computer-readable medium including executable instructions, the executable instructions being executable by one or more processors to perform a method, the method including: receiving a first 3D representation of a first portion of an environment; receiving a second 3D representation of a second portion of the environment, the first 3D representation and the second 3D representation being aligned to a common coordinate system based on a request to align the first 3D representation and the second 3D representation, the first 3D representation and the second 3D representation being grouped based on a request to combine the first 3D representation and the second 3D representation; displaying at least some of the first 3D representation in a first viewport; displaying at least some of the second 3D representation in a second viewport; receiving one or more inputs to navigate the first 3D representation; moving, based on the one or more inputs, a first virtual camera in the first 3D representation; and moving, based on the one or more inputs, a second virtual camera in the second 3D representation.

In some aspects, the techniques described herein relate to a non-transitory computer-readable medium wherein the first virtual camera is substantially synchronized with the second virtual camera.

In some aspects, the techniques described herein relate to a non-transitory computer-readable medium, the method further including: receiving a request to disable synchronization of the first virtual camera with the second virtual camera; and disabling, based on the request, synchronization of the first virtual camera with the second virtual camera, wherein the first virtual camera is no longer synchronized with the second virtual camera.

In some aspects, the techniques described herein relate to a non-transitory computer-readable medium wherein the first viewport and the second viewport are adjacent.

In some aspects, the techniques described herein relate to a non-transitory computer-readable medium wherein the first viewport and the second viewport provide a side-by-side view of the first 3D representation and the second 3D representation.

In some aspects, the techniques described herein relate to a non-transitory computer-readable medium wherein the first viewport and the second viewport provide a split view of the first 3D representation and the second 3D representation.

In some aspects, the techniques described herein relate to a non-transitory computer-readable medium wherein the second viewport is overlaid on the first viewport.

In some aspects, the techniques described herein relate to a non-transitory computer-readable medium wherein displaying at least some of the second 3D representation in the second viewport includes displaying a second portion of the second 3D representation in the second viewport in place of a corresponding first portion of the first 3D representation.

In some aspects, the techniques described herein relate to a non-transitory computer-readable medium wherein the one or more inputs are one or more first inputs, and the method further including: receiving one or more second inputs to resize or reposition the second viewport; and resizing or repositioning, based on the one or more second inputs, the second viewport.

In some aspects, the techniques described herein relate to a non-transitory computer-readable medium wherein the second 3D representation includes a redesign of the first portion of the environment.

In some aspects, the techniques described herein relate to a system including at least one processor and at least one memory including executable instructions that, when executed by the at least one processor, cause the system to: receive a first 3D representation of a first portion of an environment; receive a second 3D representation of a second portion of the environment, the first 3D representation and the second 3D representation being aligned to a common coordinate system based on a request to align the first 3D representation and the second 3D representation, the first 3D representation and the second 3D representation being grouped based on a request to combine the first 3D representation and the second 3D representation; display at least some of the first 3D representation in a first viewport; display at least some of the second 3D representation in a second viewport; receive one or more inputs to navigate the first 3D representation; move, based on the one or more inputs, a first virtual camera in the first 3D representation; and move, based on the one or more inputs, a second virtual camera in the second 3D representation.

### BRIEF DESCRIPTION OF THE DRAWINGS

FIG. 1 depicts an example environment in which a 3D representation system according to some embodiments may operate.

FIG. 2A depicts an example capture system in the form of a 3D camera according to some embodiments.

FIG. 2B depicts another example capture system in the form of an aerial drone in some embodiments.

FIG. 3 is a block diagram depicting components of a 3D representation system according to some embodiments.

FIGS. 4A-11C depict various scenarios for which a 3D representation system may combine 3D representations in some embodiments.

FIGS. 12A-12T depict an example interface for combining 3D representations that may be provided by a 3D representation system according to some embodiments.

FIGS. 13A and 13B depict another example interface for combining 3D representations that may be provided by a 3D representation system in some embodiments.

FIG. 14 depicts another example interface for combining 3D representations that may be provided by a 3D representation system according to some embodiments.

FIGS. 15-22 depict example interfaces for displaying combined 3D representations that may be provided by a 3D representation system in some embodiments.

FIG. 23 depicts interfaces for associating an annotation of one 3D representation with another 3D representation that a 3D representation system according to some embodiments may implement.

FIG. 24 depicts example common coordinate systems that a 3D representation system in some embodiments may utilize.

FIG. 25 is a flow diagram depicting a method for providing a request to combine two 3D representations that a 3D representation system according to some embodiments may implement.

FIG. 26 is a flow diagram depicting a method for displaying combined 3D representations that a 3D representation system according to some embodiments may implement.

FIG. 27 is a block diagram of an example digital device according to various embodiments.

Throughout the drawings, like reference numerals will be understood to refer to like parts, components, and structures.

### DETAILED DESCRIPTION

Conventional systems for generating and managing 3D models are inadequate for users who need to combine multiple 3D models, update previously captured environments, or navigate across related models. Existing platforms generally treat each captured space or scan job as an isolated digital artifact, offering no robust tools for merging, grouping, or aligning such 3D models. As a result, users who wish to create a unified representation from multiple scan jobs, such as a large facility, a multi-floor building captured in sections, or a space scanned collaboratively by several contributors, must rely on manual, external, or support-driven workflows that are slow, costly, and error-prone. These limitations significantly impede the ability to produce timely, accurate, and integrated 3D environments. Another major shortcoming in current solutions is the absence of any self-service mechanism for merging multiple models into a single, coherent digital space. When existing mobile scanning applications are forced to split capture sessions due to device performance limitations, users may be left with multiple disjointed 3D models that cannot be combined.

Current technologies also lack practical mechanisms for updating only a portion of an existing 3D model. When users need to revise a small region, such as to capture renovations, seasonal changes, or corrections, they are required to duplicate the 3D model, delete outdated scans, rescan the relevant areas, and hope that these newly captured areas align correctly with the retained portions. This workflow is both inefficient and unreliable, and does not provide users with any tools for partial-model merging or targeted updates. Additionally, coordinate systems may shift with each upload or version, leaving users without a consistent spatial reference across model revisions. Annotations, such as tags, labels, or metadata, likewise cannot be transferred across versions, resulting in lost work and further discouraging users from updating their models.

Users seeking to manage multiple related 3D models (for example, different units in an apartment complex, wings of a hotel captured as separate spaces, or non-overlapping buildings on a campus) face additional obstacles. Existing platforms do not support grouping or spatially arranging related 3D models using a common coordinate frame. Nor do they provide tools for discovering relationships between 3D models or visually navigating between them. These deficiencies create a fragmented and unintuitive navigation experience that does not approximate continuous spatial exploration across distinct but conceptually related 3D models.

Moreover, current systems offer no native functionality for comparing 3D models across time, configurations, or other dimensions. Users who wish to examine differences between successive versions of a space, or between alternate configurations, such as staged versus empty interiors, must manually manage separate 3D models with no alignment, synchronization, or cross-referencing capabilities. There is also no facility for adjusting or correcting geolocation attributes, such as Global Positioning System (GPS) coordinates, compass orientation, or altitude. Without tools to harmonize models within a shared coordinate system, users are unable to view spaces consistently over time or to integrate external datasets (for example, BIM files or asset-specific scans) into a unified spatial context.

Described herein is a 3D representation system that provides technical solutions to these and other technical problems. The 3D representation system may enable users to seamlessly merge multiple 3D representations, including those originating from separate scan jobs, separate collaborators (team scanning), or split mobile capture sessions, into a unified 3D representation. With a single user action (for example, a merge request in an interface provided by the 3D representation system), separate 3D representations can be positioned relative to one another, aligned to a common coordinate system, and combined, allowing users to quickly and easily generate integrated 3D representations even for large, intricate, or disparate properties (for example, high-rises, industrial parks, or multi-building sites). The 3D representation system may further implement resource-aware merging that manages voxel budgets and optimizes mesh fidelity, addressing processing-scale limits while maintaining visual and geometric quality.

The 3D representation system may also update an existing 3D representation by integrating a 3D representation generated from a newly captured partial scan with the existing 3D representation. Rather than requiring a user to delete outdated scan data, duplicate projects, or manually realign rescanned portions, the 3D representation system may automatically align updated captures to a stable, common coordinate system across versions and preserve annotations (for example, tags, labels, or other metadata) by transferring or mapping them to the new 3D representation generated from the existing 3D representation and the other 3D representation. This reduces the friction and error risk of revising prior work while ensuring that previously created information remains intact. The same interface may be used to load any number of 3D representations, position and align them relative to one another (for example, floor-to-floor or building-to-building), and merge them, so that multiple floors, separate buildings, and even indoor and outdoor portions captured in different sessions can be combined into a single, easy-to-navigate 3D representation.

Beyond merging, the 3D representation system may spatially organize and group related 3D representations that are physically separated (for example, apartments within a complex, buildings across a campus, or interior or exterior environments), enabling exploration of related 3D representations as one collection without requiring them to be a single 3D representation. To support intuitive navigation, the 3D representation system may provide cross-3D representation navigation pathways that allow seamless transitions between distinct 3D representations, including team-captured or non-overlapping portions, while preserving independent storage and processing. In addition, by establishing and maintaining transforms to a common coordinate system (and, when needed, to external coordinate systems such as GPS or third-party jobsite references), the 3D representation system may enable time-based navigation (which may be referred to herein as time travel), side-by-side comparisons, and configuration-specific views (for example, furnished versus unfurnished) across versions and scenarios, with optional alignment refinements and geolocation adjustments (for example, compass heading or altitude).

By providing the above interactive merge or update workflow, team-scan support, large-site composition (including indoor-outdoor continuity), grouping, alignment, navigation, temporal comparison, and coordinate-system management, the 3D representation system addresses long-standing deficiencies in existing solutions. Collectively, these capabilities allow users to create, maintain, explore, and analyze complex multiple 3D representations with substantially greater speed, accuracy, and operational scale than was previously possible, while keeping the user experience intuitive.

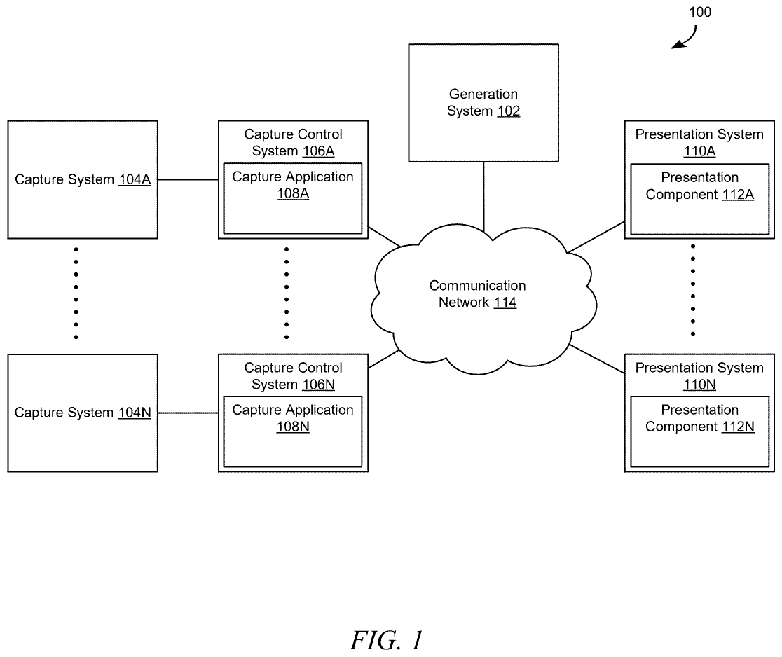

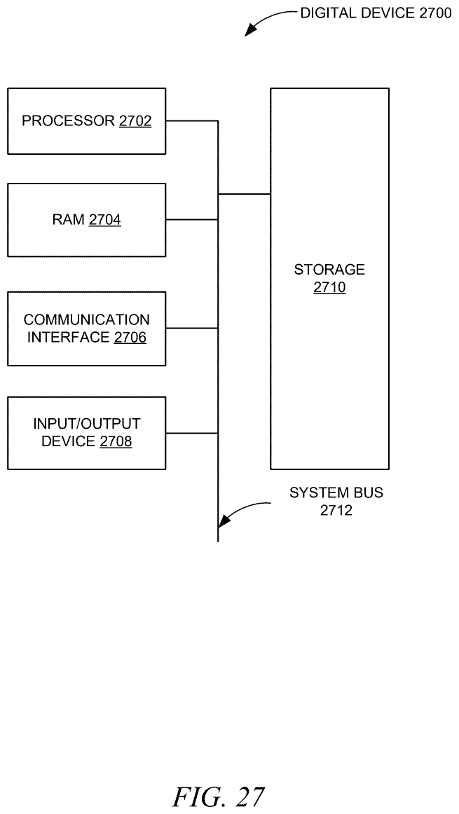

FIG. 1 depicts an example environment 100 in which a 3D representation system according to some embodiments may operate. The environment 100 includes multiple capture systems 104A through 104N (which may be referred to as a capture system 104 or as capture systems 104), multiple capture control systems 106A through 106N (which may be referred to as a capture control system 106 or as capture control systems 106), a generation system 102, multiple presentation systems 110A through 110N (which may be referred to as a presentation system 110 or as presentation systems 110), and a communication network 114. Each of the capture systems 104, the capture control systems 106, the generation system 102, and the presentation systems 110 may be or include any number of digital devices. A digital device is any device with at least one processor and memory. Digital devices are discussed further herein, for example, with reference to FIG. 27.

The capture systems 104 may each be or include a system that is configured to capture images, video, or 3D data of physical environments, such as buildings (for example, houses or office buildings), other structures, or outdoor environments. For example, the capture systems 104 may have scanning functionality to capture 3D data (for example, using a laser imaging, detection, and ranging device (LiDAR)) and imaging functionality to capture images or video (for example, using imaging sensors). The capture systems 104 may also capture other sensor data, such as GPS or A-GPS data or other location data. Examples of capture systems 104 are 3D cameras such as the Matterport Pro 3 camera, 360-degree cameras such as the Ricoh Theta series of 360-degree cameras, mobile phones or tablets such as iOS operating system phones or tablets and Android operating system phones or tablets, and aerial drones. The capture systems 104 are not limited to the examples described herein.

The capture control systems 106 may each be or include a system that includes a capture application 108 (shown individually as capture applications 108A through 108N) that is configured to control the capture of the images, video, 3D data, or other sensor data by the capture systems 104. The capture applications 108 may also capture other sensor data, such as GPS or A-GPS data or other location data. Examples of capture control systems 106 are mobile phones or tablets such as iOS operating system phones or tablets and Android operating system phones or tablets. One example of a capture application is the Matterport application for iOS or Android. The capture control systems 106 are not limited to the examples described herein. Similarly, the capture applications 108 are not limited to the example described herein.

The capture systems 104 may provide the captured images, video, 3D data, or other sensor data (which may be referred to individually or in a group as captured data, captured content, content, or data) to the capture applications 108. The capture systems 104 may provide the captured data to the capture applications 108 via a Wi-Fi connection, a Bluetooth Low Energy (BLE) connection, or a wired connection with the capture control systems 106. The capture applications 108 may process the captured data. The capture applications 108 may provide, implement, or enable other functionality or features and are not limited to those described herein.

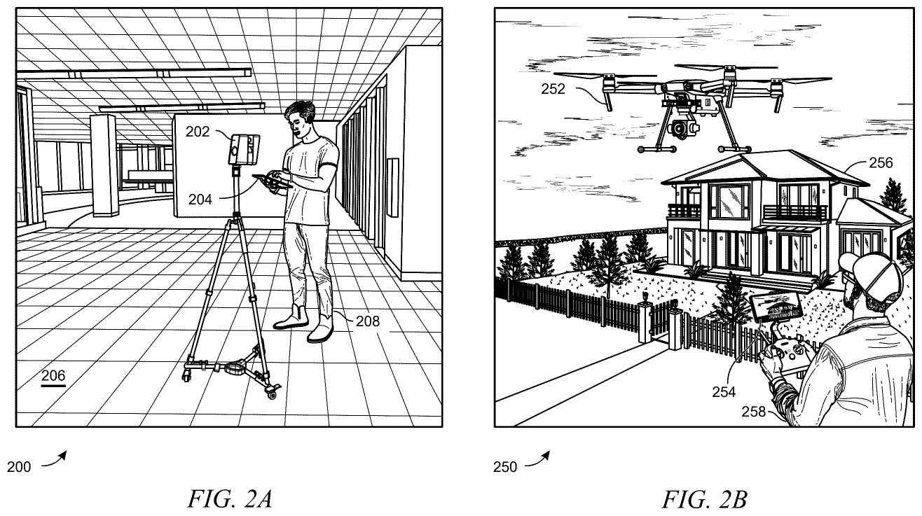

FIG. 2A depicts an example capture system 104 in the form of a 3D camera 202 and an example capture control system 106 in the form of a mobile tablet 204 according to some embodiments. A user 208 may utilize a capture application 108 (not illustrated in FIG. 2A) that the mobile tablet 204 may execute to control the 3D camera 202 to capture images, video, 3D data, or other sensor data of the environment 200, which includes a building 206. FIG. 2B depicts another example capture system 104 in the form of an aerial drone 252 and another example capture control system 106 in the form of a mobile phone 254 in some embodiments. A user 258 may utilize a capture application 108 (not illustrated in FIG. 2B) that the mobile phone 254 may execute to control the aerial drone 252 to capture images, video, 3D data, or other sensor data of the environment 250, which includes a building 256.

Other examples of capture systems 104 are a mobile robot carrying a camera that may be utilized to continuously capture data, a 3D camera, a 360 camera, or other capture device carried by a human, such as on a pole, and cameras or other sensors placed at multiple locations and capturing data at each location. In some embodiments, the functionality or features of the capture application 108 or the capture control system 106 are included in the capture system 104.

Returning to FIG. 1, the capture applications 108 may provide the captured data to the generation system 102. The generation system 102 may be or include a system that is configured to receive the captured data and process the captured data. As described in more detail herein, the generation system 102 may also utilize the captured data to generate 3D representations and other data. The generation system 102 may also align 3D representations and combine 3D representations, such as by merging 3D representations or by grouping 3D representations. The generation system 102 may also modify 3D representations. The generation system 102 may provide, implement, or enable other functionality or features and is not limited to those described herein.

The generation system 102 may provide 3D representations to the presentation systems 110. The presentation systems 110 may each be or include a system that includes a presentation component 112 (shown individually as presentation components 112A through 112N) that is configured to display 3D representations (for example, using one or more display devices) and provide other functionality. Examples of presentation systems 110 are mobile phones or tablets, desktop or laptop computing devices, virtual or augmented reality devices, and televisions. One example of a presentation component is the Matterport 3D Showcase interactive web player that may be included in a web browser that may execute on a desktop or laptop computing device or on a mobile phone or tablet. In some embodiments, the capture applications 108 include the presentation components 112 or equivalent functionality. For example, the Matterport application may display 3D representations and allow for navigation and exploration of 3D representations.

The presentation component 112 may allow for viewing, navigating, exploring, modifying, aligning, or combining 3D representations. For example, the presentation component 112 may allow a user to view a 3D representation and navigate in the 3D representation. The presentation component 112 may also allow users to modify a 3D representation, such as by changing properties of the 3D representation or by adding annotations to the 3D representation. The presentation component 112 may also allow users to align 3D representations and request that 3D representations be combined, such as that 3D representations be merged or grouped. The presentation component 112 may provide, implement, or enable other functionality or features and is not limited to those described herein.

The capture system 104, the capture application 108, the generation system 102, and the presentation component 112 (individually or in a group) may be referred to herein as a 3D representation system. Accordingly, the 3D representation system may be interpreted as comprising any of the capture system 104, the capture application 108, the generation system 102, or the presentation component 112. Similarly, functionality described as performed by the 3D representation system may be performed by any of the capture system 104, the capture application 108, the generation system 102, or the presentation component 112.

In some embodiments, the communication network 114 may represent one or more computer networks (for example, local area networks (LANs), wide area networks (WANs), or the like). The communication network 114 may provide or facilitate communication between any of the generation system 102, the capture systems 104, the capture control systems 106, and the presentation systems 110. In some implementations, the communication network 114 comprises computer devices, routers, cables, or other network topologies. In some embodiments, the communication network 114 may be wired or wireless. In various embodiments, the communication network 114 may comprise the Internet, one or more networks that may be public, private, IP-based, non-IP-based, and so forth.

Although the environment 100 depicted in FIG. 1 has a specific configuration and the corresponding description discusses specific functionality and features, it is to be understood that variations of the configuration depicted, or the functionality and features described, are possible. For example, a capture system 104 may include control interfaces that a user may utilize to control the capture system 104 to capture data, and the capture system 104 may provide the captured data to the generation system 102 without providing it to a capture application 108. As another example, there may be multiple generation systems 102. As another example, the generation system 102 may provide 3D representations to other systems not in the environment 100 (for example, computing systems of real-estate listing websites or other property information websites) for display. Accordingly, the disclosure is not limited to the description herein.

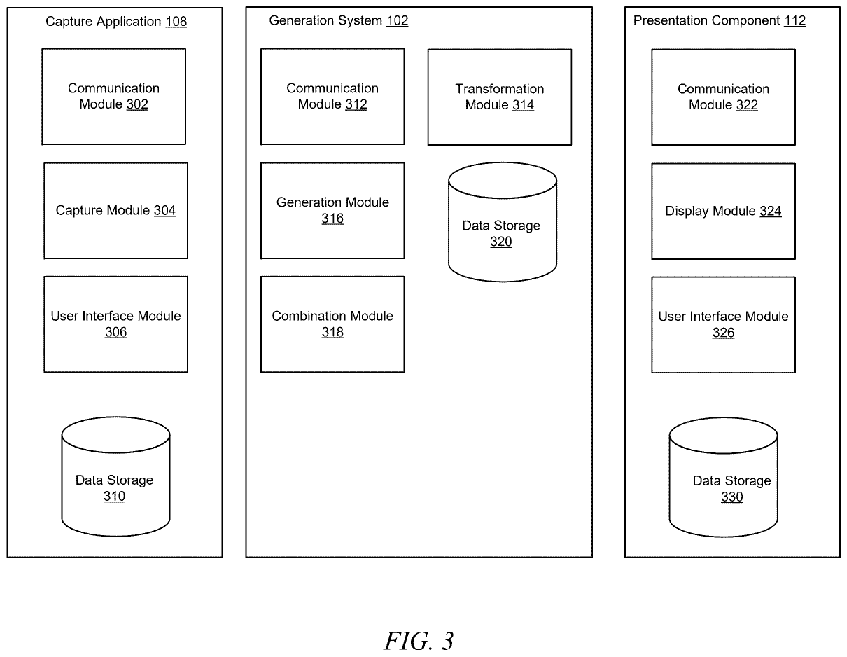

FIG. 3 is a block diagram depicting components of the capture application 108, components of the generation system 102, and components of the presentation component 112 according to some embodiments. The capture application 108 may include a communication module 302, a capture module 304, a user interface module 306, and a data storage 310. The generation system 102 may include a communication module 312, a transformation module 314, a generation module 316, a combination module 318, and a data storage 320. The presentation component 112 may include a communication module 322, a display module 324, a user interface module 326, and a data storage 330.

The communication module 302 of the capture application 108 may send requests or data between the capture application 108 and any of the capture system 104, the generation system 102, and the presentation system 110. The communication module 312 of the generation system 102 and the communication module 322 of the presentation component 112 may perform similar functionality for the generation system 102 and the presentation system 110, respectively.

The capture module 304 of the capture application 108 may control the capture system 104 to capture images, video, or 3D data of physical environments. The user interface module 306 of the capture application 108 may provide user interfaces for users to utilize to control the capture control systems 106.

The transformation module 314 of the generation system 102 may transform or reconstruct captured data or other data. The generation module 316 of the generation system 102 may generate 3D representations and other data. The combination module 318 may align or combine 3D representations, such as by merging 3D representations or by grouping 3D representations.

The display module 324 of the presentation component 112 may display 3D representations and other data. The user interface module 326 of the presentation component 112 may provide user interfaces for users to utilize to view, navigate, modify, align, or combine 3D representations.

The data storage 310 may include data stored, accessed, or modified by any of the modules of the capture application 108, the data storage 320 may include data stored, accessed, or modified by any of the modules of the generation system 102, and the data storage 330 may include data stored, accessed, or modified by any of the modules of the presentation component 112. The data storage 310, the data storage 320, or the data storage 330 may include any number of data storage structures such as tables, databases, lists, or the like. The data storage 310, the data storage 320, or the data storage 330 may include data that is stored in memory (for example, random access memory (RAM)), on disk or on solid-state devices, or some combination of in-memory and on-disk or on solid-state devices.

A module of the capture application 108, of the generation system 102, or of the presentation component 112 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in random access memory (RAM) or read-only memory (ROM), or any combination. Software may be executed by one or more processors. Although a limited number of modules are depicted in FIG. 3, there may be any number of modules. Further, individual modules may perform any number of functions, including functions of multiple modules as described herein.

### Content

The types of content that the 3D representation system may utilize may include any of the following, alone or in combination: two-dimensional (2D) images or video; 3D meshes or other 3D surface representations; spatial data, including map data; point clouds or other 3D clouds; radiance fields or other neural representations; and voxel or other volumetric or solid representations, such as constructive solid geometry (CSG) representations.

2D images or video may be or include flat images, fisheye, panoramic, or other projections. The 2D images or video may include or have associated metadata such as camera or image position, orientation, or intrinsics to enable positioning or projection of the 2D content in 3D.

3D meshes or other 3D surface representations may be textured or untextured, optionally including view-dependent texturing. 3D meshes or other 3D surface representations may include surface properties such as normal maps or other information, may include multiple scales or levels of detail, or may include wireframes or other stylized rendering techniques.

Spatial data may include map data. Map data may include information about the locations or properties of objects, locations, or regions. Map data may also include data for streets, buildings, terrain types or features, points of interest, planned routes, or the like. Spatial data may be presented as 2D (for example, icons) or 3D (for example, meshes, 3D lines, or other 3D shapes). Spatial data may also include auxiliary or derived data such as bounding boxes or preview panes with additional content such as text, images, or video. Spatial data may also have associated non-spatial data with spatial tagging or associations, such as temperature data with a known sensor location.

Point clouds or other 3D clouds may include clouds where each element has a more complex representation than a point, such as surfel clouds or Gaussian splats. Gaussian splats may refer to representing a 3D scene using a collection of generally smooth ellipsoidal shapes defined by Gaussian functions. Each Gaussian splat may have a position in 3D space, a size (its covariance), a color, and an opacity. When rendered, these Gaussian splats may be projected and blended together to produce a generally continuous image. Point clouds or other 3D clouds may include color, transparency, orientation, size, or other properties for each element.

Radiance fields or other neural representations may include direct (for example, rendering each pixel using a NeRF) or derived or simplified (for example, a mesh with MLP-based textures) representations.

Any of the types of content described herein may be dynamic. Examples of dynamic content are live or updated data such as traffic data for maps, data from Internet of Things (IoT) devices, 2D or 3D data updated using sensors viewing the space such as video cameras, or content that is inherently variable or parameterized such as an animated 3D mesh. Additionally or alternatively, the content may be updated or edited by a user viewing the content or by other persons or systems.

### Combining 3D Representations

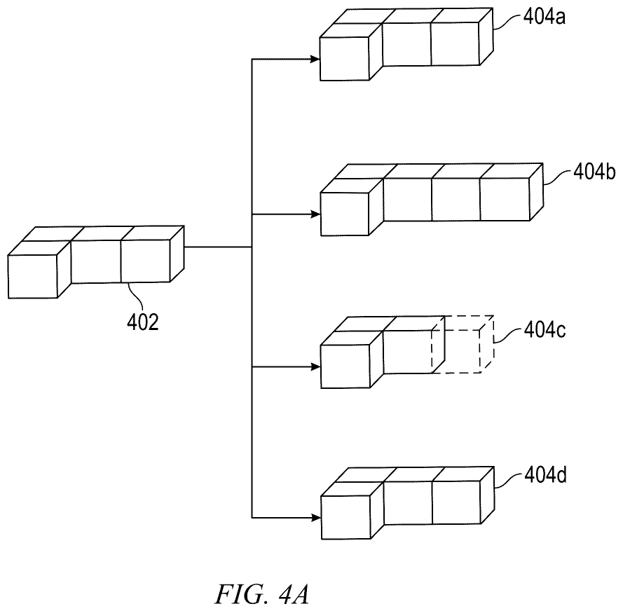

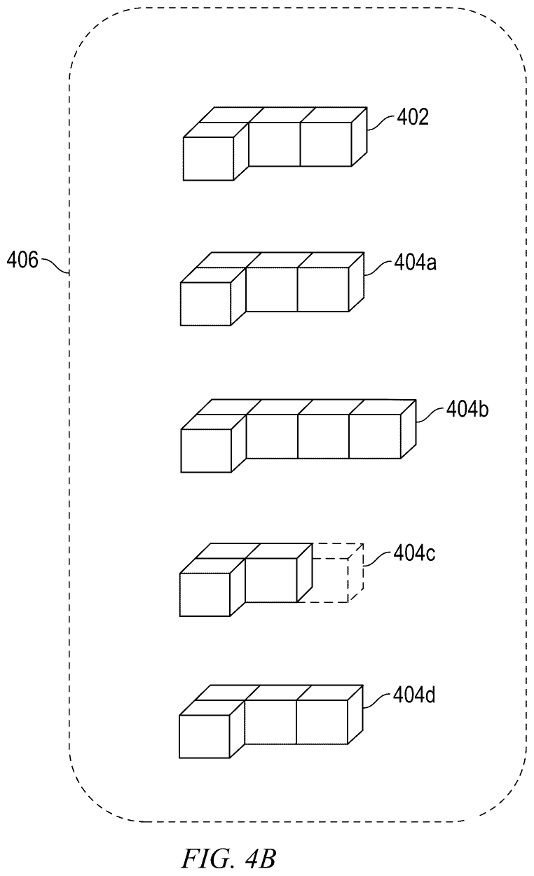

FIGS. 4A-11C depict various scenarios for which the 3D representation system may combine 3D representations in some embodiments, such as by merging multiple 3D representations into a single 3D representation or by grouping multiple 3D representations. FIG. 4A illustrates a scenario where the 3D representation system may generate multiple 3D representations for an environment. The 3D representation system may combine two or more 3D representations. The two or more 3D representations may have the same type. For example, each of the two or more 3D representations may be primarily a 3D mesh. The two or more 3D representations may have a combination of types. For example, one or more of the 3D representations may be primarily 3D mesh and one or more of the 3D representations may be primarily Gaussian splats. As another example, one or more of the 3D representations may be primarily 360-degree images and one or more of the 3D representations may be primarily 3D mesh. It will be understood that the 3D representations may combine 3D representations of types different from the examples described herein. The 3D representation system may combine 3D representations from separate scan sessions, from separate devices (for example, scanning done by multiple devices), or split mobile capture sessions, into one or more 3D representations.

The 3D representation system may generate a first 3D representation 402 of the environment using first data from a first capture session of the environment. The 3D representation system may also generate a second 3D representation 404a using the first data, such as in response to a user providing the first data to the 3D representation system a second time. The second 3D representation 404a may have the same scan points as the first 3D representation 402, and the mesh and metadata for the first 3D representation 402 and the second 3D representation 404a may largely match, although there may be differences. The 3D representation system may also receive a request to add second data from the first capture session or another capture session of the environment and add the second data to the first 3D representation 402. The 3D representation system may utilize the second data to generate a third 3D representation 404b. In this case, some scan points, mesh, and metadata of the third 3D representation 404b may match that of the first 3D representation 402, although there will be new additional mesh and optionally metadata.

The 3D representation system may also receive a request to delete data from the first 3D representation 402. The 3D representation system may do so and generate a third 3D representation 404c. In this case, the scan points, mesh, and metadata for the third 3D representation 404c match that for the first 3D representation 402, although there is less mesh and potentially less metadata for the third 3D representation 404c. The 3D representation system may also receive a request to add third data from the first capture session or another capture session of the environment and utilize the third data to replace certain data of the first 3D representation 402. The 3D representation system may do so and generate a fourth 3D representation 404d.

In various embodiments, the 3D representation system may match 3D representations based on various factors. For example, the 3D representation system may utilize the types of the capture data or the unique identifiers of the capture data or the 3D representations (which may be related in some cases) to match the 3D representation 402 to one of the 3D representations 404a-404d. The 3D representation system may group the matched 3D representations.

FIG. 4B illustrates a group 406 of the first 3D representation 402 and the 3D representations 404a-404d. In various embodiments, the 3D representation system may determine how to group the first 3D representation 402 and the 3D representations 404a-404d based on multiple factors. For example, the 3D representation system may utilize types of capture data, unique identifiers of the scan data or representations, relationships between the 3D representations, or overlap among scan points, mesh, and metadata to match the first 3D representation 402 to one or more of the 3D representations 404a-404d when forming the group 406. These factors may assist the 3D representation system in identifying related 3D representations produced from the same environment or capture lineage, enabling the 3D representation system to organize them into a group for comparison, visualization, further editing, alignment to a common coordinate system, or potential later combination or merging operations.

In various embodiments, the 3D representation system may receive a request to group the first 3D representation 402 with one or more of the 3D representations 404a-404d and may generate the group 406 that includes the first 3D representation 402 with one or more of the additional 3D representations 404a-404d. The grouped 3D representations may remain distinct but may be aligned or arranged relative to one another for coordinated viewing or processing.

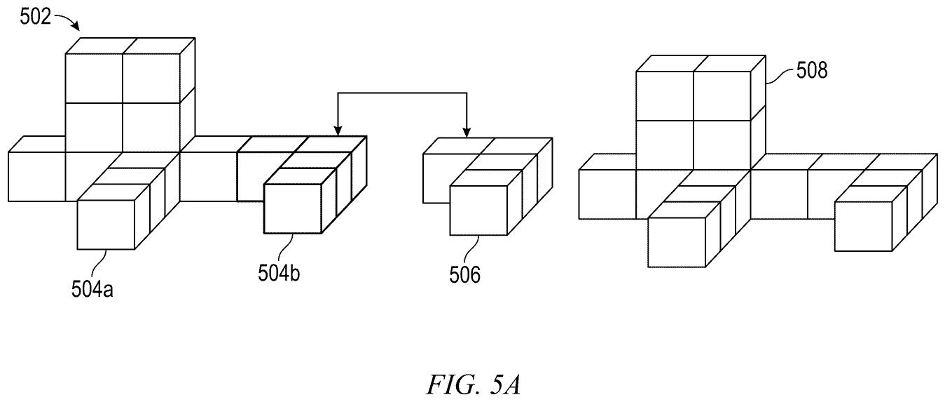

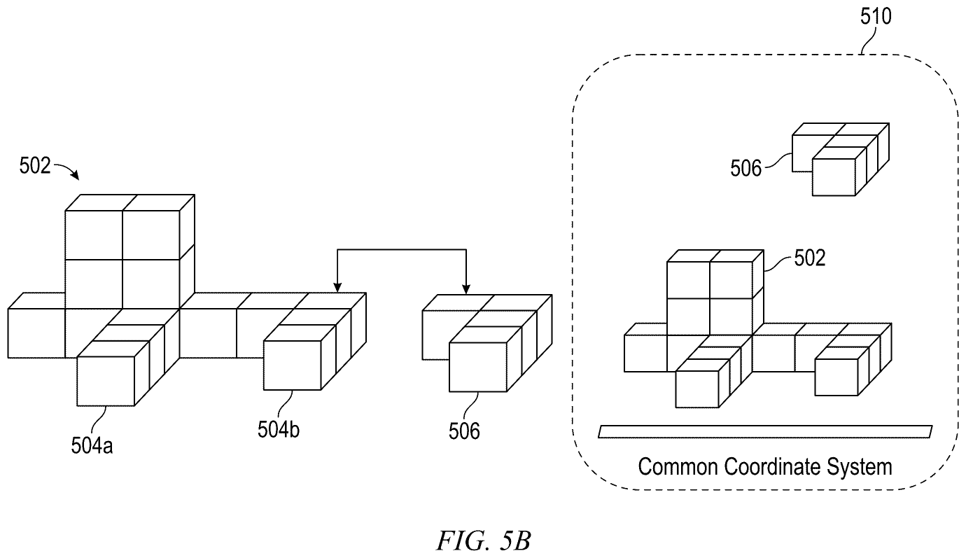

FIG. 5A illustrates a scenario in which the 3D representation system may generate a combined 3D representation of an environment from two 3D representations of portions of the environment. The 3D representation system may access a first 3D representation 502 of the environment. The first 3D representation 502 may include a first portion 504a for a first portion of the environment and a second portion 504b for a second portion of the environment. The 3D representation system may also access a second 3D representation 506 that may correspond to the second portion 504b. For example, the 3D representation system may generate the second 3D representation 506 using capture data from another capture session for the second portion of the environment. Although the second 3D representation 506 is depicted as corresponding to the second portion 504b of the first 3D representation 502, the second 3D representation 506 may correspond to any portion of the first 3D representation 502. Moreover, although only the second 3D representation 506 is depicted, there may be more than one second 3D representation, each of which may correspond to a different portion of the first 3D representation 502.

The 3D representation system may merge the first 3D representation 502 and the second 3D representation 506 to generate a third 3D representation 508. The 3D representation system may generate the third 3D representation 508 by replacing at least substantially all of the second portion 504b with at least substantially all of the second 3D representation 506. As discussed in more detail herein, in some embodiments, prior to combining, the 3D representation system may align the first 3D representation 502 and the second 3D representation 506 prior to merging the first 3D representation 502 and the second 3D representation 506 to generate the third 3D representation 508. FIG. 5A depicts a scenario in which the first 3D representation 502 and the second 3D representation 506 may be independent without a preexisting linkage. Accordingly, the 3D representation system may rely on pose adjustments, overlap between scan points, or structural cues in the meshes of the first 3D representation 502 and the second 3D representation 506 to align the first 3D representation 502 and the second 3D representation 506 prior to merging the first 3D representation 502 and the second 3D representation 506. In aligning 3D representations, the 3D representation system may utilize the alignment techniques described herein (or any suitable alignment techniques) to align the 3D representations.

Also, as discussed in more detail herein, in various embodiments, the 3D representation system may provide one or more user interfaces that display multiple 3D representations. The one or more user interfaces may allow users to provide inputs to move one or more of the 3D representations for purposes of aligning the 3D representations or in aiding the alignment of the 3D representations.

FIG. 5B illustrates a scenario in which the 3D representation system may access a first 3D representation 502 of an environment that includes a first portion 504a and a second portion 504b. The 3D representation system may also access a second 3D representation 506 corresponding to an updated or rescanned version of the second portion 504b. For example, the second 3D representation 506 may be generated from capture data obtained during a later capture session in which at least a portion of the environment represented by the second portion 504b was rescanned. The 3D representation system may generate a group 510 that includes the first 3D representation 502 and the second 3D representation 506. The group 510 may allow for the two 3D representations to be jointly utilized for various purposes.

In various embodiments, the 3D representation system may group the first 3D representation 502 and the second 3D representation 506 to allow users to compare the second portion 504b to the updated second 3D representation 506. Grouping the first 3D representation 502 and the second 3D representation 506 may also support time-based viewing, such as viewing how the second portion 504b changed over time. Such time-based viewing may be referred to herein as time travel. The grouping operation may preserve the distinctness of the first 3D representation 502 and the second 3D representation 506 while allowing the first 3D representation 502 and the second 3D representation 506 to be arranged or aligned relative to a common coordinate system. In some embodiments, the first 3D representation 502 and the second 3D representation 506 are aligned prior to being grouped.

In some embodiments, the 3D representation system may treat the grouped first 3D representation 502 and second 3D representation 506 as a single 3D representation for certain purposes, such as creating a unified viewing experience or navigating seamlessly between the portions. In other embodiments, the 3D representation system may maintain the first 3D representation 502 and the second 3D representation 506 as grouped but separate 3D representations, enabling selective toggling, comparison, and time travel functionality. Accordingly, the 3D representation system may allow a user to examine updated portions of an environment while retaining access to the corresponding earlier portions of the environment.

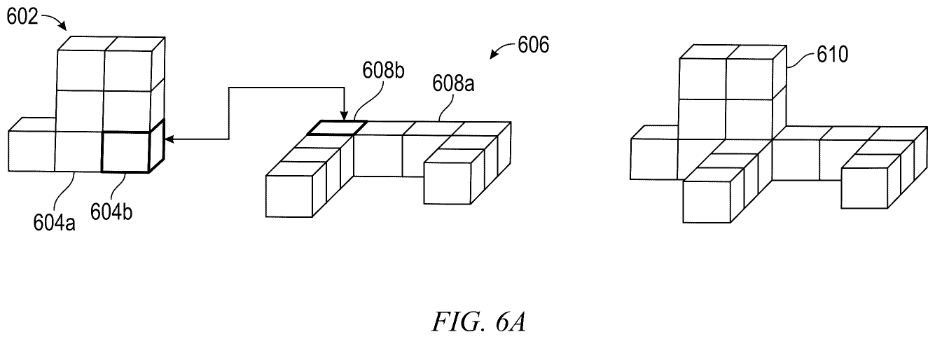

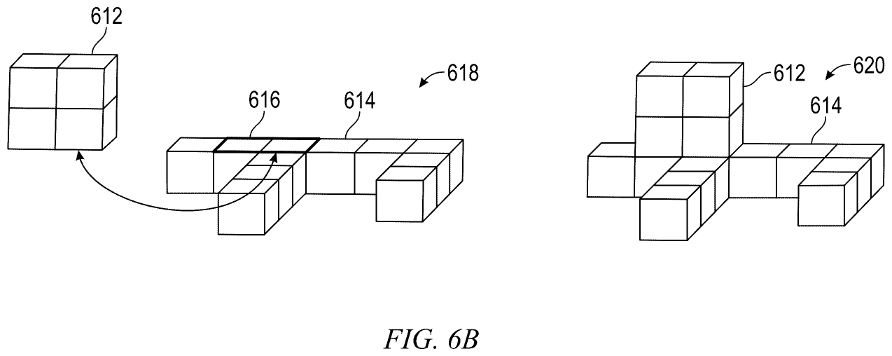

FIG. 6A illustrates a scenario in which the 3D representation system may access a first 3D representation 602 of a first portion of an environment and a second 3D representation 606 of a second portion of the environment. The 3D representation system may have generated the first 3D representation 602 and the second 3D representation 606 from first capture data and second capture data, respectively. The first capture data and the second capture data may have been obtained at generally the same time or at generally similar times. The first capture data and the second capture data may have been captured during one or more capture sessions involving one or more individuals or one or more capture devices.

The first 3D representation 602 includes a first portion 604a and a second portion 604b, and the second 3D representation 606 includes a first portion 608a and a second portion 608b. As depicted in FIG. 6A, the second portion 604b of the first 3D representation 602 and the second portion 608b of the second 3D representation 606 overlap. For example, in a team capture scenario, portions of the environment may be scanned by different capture devices in close temporal proximity, resulting in overlapping coverage. The 3D representation system may identify that the second portion 604b of the first 3D representation 602 overlaps with the second portion 608b of the second 3D representation 606.

In various embodiments, when the 3D representation system determines that there is overlap among two or more 3D representations, the 3D representation system may merge the overlapping 3D representations. As depicted in FIG. 6A, the 3D representation system may merge the first 3D representation 602 and the second 3D representation 606 to generate a third 3D representation 610. The third 3D representation 610 may include the first portion 604a of the first 3D representation 602 and the first portion 608a of the second 3D representation 606. The third 3D representation 610 may also include the second portion 604b (at least substantially all of the second portion 604b) of the first 3D representation 602 or the second portion 608b (at least substantially all of the second portion 608b) of the second 3D representation 606. In some embodiments, the third 3D representation 610 includes some of the second portion 604b and some of the second portion 608b. The 3D representation system may blend overlapping sections (for example, textures of overlapping sections) or utilize other techniques to facilitate transitions between the non-overlapping sections and the overlapping sections of the third 3D representation 610.

In some embodiments, prior to merging, the 3D representation system may align the first 3D representation 602 and the second 3D representation 606. Because the first 3D representation 602 and the second 3D representation 606 have overlapping portions, the overlapping portions may assist the 3D representation system in performing alignment based on structural cues in the meshes, matching scan points, or other shared attributes.

FIG. 6B illustrates a scenario in which the 3D representation system may access a first 3D representation 612 of a first portion of an environment and a second 3D representation 618 of a second portion of the environment. The second 3D representation 618 includes a first portion 614 and a second portion 616. As depicted in FIG. 6B, the first 3D representation 612 and the second 3D representation 618 do not have overlapping portions. For example, the first 3D representation 612 and the second 3D representation 618 may have been generated from capture sessions performed in physically separated regions of the environment or from non-overlapping paths taken during the capture sessions. The absence of overlapping coverage may prevent the 3D representation system from relying on matching scan points or shared mesh structure to align the two 3D representations.

In various embodiments, when two 3D representations do not overlap, the 3D representation system may utilize other techniques to align the first 3D representation 612 and the second 3D representation 618. The 3D representation system may identify openings, such as doors, windows, or other architectural transitions, that provide a logical adjacency between the portions of the environment represented in the first 3D representation 612 and the second 3D representation 618. The 3D representation system may also identify related surfaces, such as opposing sides of a shared wall or floor surfaces that should be contiguous when the two 3D representations are correctly aligned. The 3D representation system may take into account dimensions of walls or floors (estimated or measured), such as thicknesses of walls or floors, in utilizing related surfaces. In addition, the 3D representation system may utilize other structural cues, geometric features, or user-provided adjustments to determine the relative placement of the first 3D representation 612 and the second 3D representation 618.

After identifying openings, related surfaces, or other cues, the 3D representation system may use these features to align the first 3D representation 612 and the second 3D representation 618, such as relative to a common coordinate system. Establishing this alignment may allow the 3D representation system to treat the first 3D representation 612 and the second 3D representation 618 as neighboring portions of the environment even though they may share no overlapping scan data. Once aligned, the 3D representation system may merge the first 3D representation 612 and the second 3D representation 618 into a third 3D representation 620. Additionally or alternatively, the 3D representation system may arrange and maintain the first 3D representation 612 and the second 3D representation 618 as grouped but distinct 3D representations for visualization, navigation, or editing purposes.

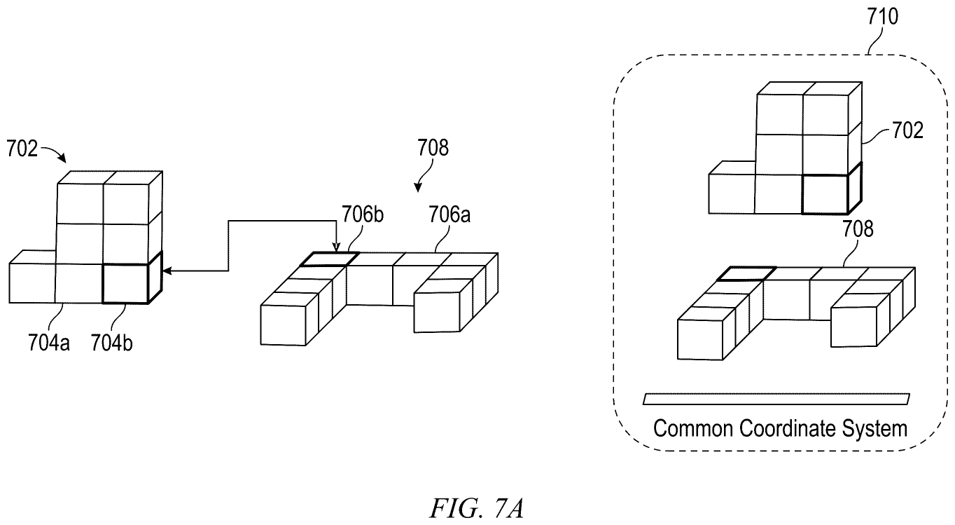

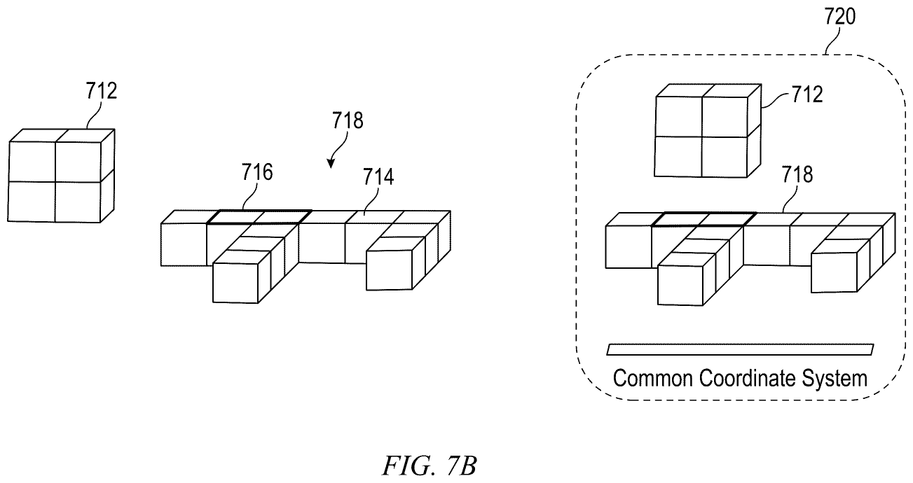

FIG. 7A illustrates a scenario in which the 3D representation system may access a first 3D representation 702 of a first portion of an environment and a second 3D representation 708 of a second portion of the environment. The first 3D representation 702 includes a first portion 704a and a second portion 704b, and the second 3D representation 708 includes a first portion 706a and a second portion 706b. As depicted in FIG. 7A, at least a portion of the first 3D representation 702 overlaps with at least a portion of the second 3D representation 708. For example, the second portion 704b of the first 3D representation 702 may correspond to the second portion 706b of the second 3D representation 708.

In some embodiments, when the 3D representation system identifies overlap between the first 3D representation 702 and the second 3D representation 708, the 3D representation system may generate a group 710 that includes the first 3D representation 702 and the second 3D representation 708. Grouping the first 3D representation 702 and the second 3D representation 708 may allow the 3D representation system to treat the overlapping portions as related portions of the environment while maintaining each 3D representation as a distinct digital construct. The group 710 may also allow the 3D representations to be arranged relative to a common coordinate system. In some embodiments, the first 3D representation 702 and the second 3D representation 708 are aligned prior to being grouped.

In some embodiments, grouping the first 3D representation 702 and the second 3D representation 708 may allow users to perform comparison, time-based analysis, or incremental updates to portions of the environment. Because the first 3D representation 702 and the second 3D representation 708 include overlapping coverage, the 3D representation system may use the overlapping portions to assist in aligning the two 3D representations within the group 710. Once aligned, the grouped 3D representations may be jointly navigated or analyzed while preserving the ability to view or manipulate the individual 3D representations separately.

FIG. 7B illustrates a scenario in which the 3D representation system may access a first 3D representation 712 of a first portion of an environment and a second 3D representation 718 of a second portion of the environment. The second 3D representation 718 includes a first portion 714 and a second portion 716. As depicted in FIG. 7B, the first 3D representation 712 and the second 3D representation 718 do not include overlapping portions. For example, the first 3D representation 712 and the second 3D representation 718 may have been generated from capture sessions performed at different times, by different capture devices, or along non-overlapping paths in the environment. Because no overlapping coverage exists, the 3D representation system may be unable to rely on shared scan points or shared mesh structure to align the two 3D representations.

In various embodiments, when two 3D representations do not overlap, the 3D representation system may still group the 3D representations. As depicted in FIG. 7B, the 3D representation system may generate a group 720 that includes the first 3D representation 712 and the second 3D representation 718. Grouping the first 3D representation 712 and the second 3D representation 718 may enable the 3D representation system to treat them as neighboring or otherwise related portions of the environment even though they share no overlapping scan data. Within the group 720, the 3D representation system may align the first 3D representation 712 and the second 3D representation 718, such as relative to a common coordinate system, such as by identifying architectural transitions, structural cues, or user-provided adjustments that indicate how the two 3D representations should be positioned with respect to one another. In some embodiments, the first 3D representation 712 and the second 3D representation 718 are aligned prior to being grouped.

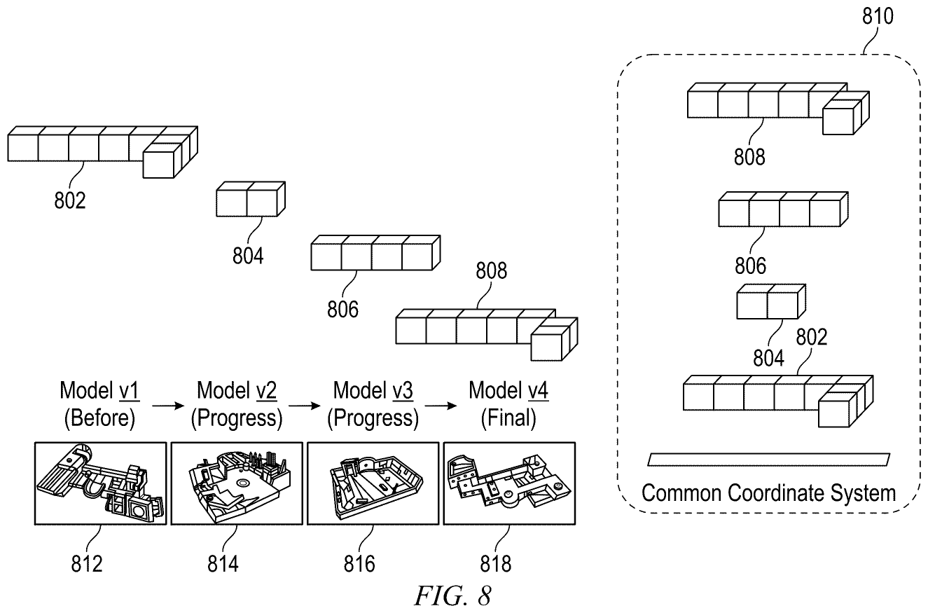

FIG. 8 illustrates a scenario in which the 3D representation system may access multiple 3D representations of portions of an environment that were generated from data captured at different times, such as during different stages of construction or remodeling of a building. As depicted in FIG. 8, the 3D representation system may access a first 3D representation 802, a second 3D representation 804, a third 3D representation 806, and a fourth 3D representation 808. 3D representation 812 (corresponding to the first 3D representation 802), 3D representation 814 (corresponding to the second 3D representation 804), 3D representation 816 (corresponding to the third 3D representation 806), and 3D representation 818 (corresponding to the fourth 3D representation 808) depict different stages of the environment, such as early construction, mid-construction, later progress, and a final completed state. Because the 3D representations correspond to varying stages of the same environment, at least portions of the 3D representations may overlap. For example, structural elements such as framing, walls, or room layouts may persist across stages even as other elements change.

In various embodiments, when the 3D representation system determines that at least some portions of the first 3D representation 802, the second 3D representation 804, the third 3D representation 806, or the fourth 3D representation 808 overlap, the 3D representation system may generate a group 810 that includes two or more of the 3D representations. Grouping the 3D representations may allow the 3D representation system to organize them in a manner that reflects their temporal or developmental relationships. Within the group 810, the 3D representation system may align the 3D representations, such as relative to a common coordinate system, by using overlapping structural features, consistent geometry, or other shared characteristics. This alignment may allow the 3D representations to be viewed or analyzed in a coordinated manner even though they were captured at different times. In some embodiments, the 3D representations may be aligned prior to being grouped.

In some embodiments, grouping the first 3D representation 802, the second 3D representation 804, the third 3D representation 806, and the fourth 3D representation 808 may allow the 3D representation system to support time travel, progress comparison, or stage-based visualization of changes to the environment. For example, a user may compare the framing condition shown in the stage associated with 3D representation 812 to the partially enclosed state shown in 3D representation 814, the more complete stage shown in 3D representation 816, or the final version shown in 3D representation 818. The overlapping regions across the 3D representations may provide stable anchor points that assist the 3D representation system in aligning earlier and later stages for side-by-side comparison or sequential temporal navigation.

In some embodiments, the 3D representation system may preserve the distinctness of each 3D representation within the group 810 while still enabling unified viewing and navigation. For example, a user may switch between the first 3D representation 802, the second 3D representation 804, the third 3D representation 806, or the fourth 3D representation 808 while remaining at the same aligned location in the environment, thereby observing differences between stages without losing spatial context. Accordingly, FIG. 8 depicts a scenario in which multiple 3D representations that include overlapping portions of the environment may be grouped for comparison, temporal analysis, remodeling review, or other purposes.

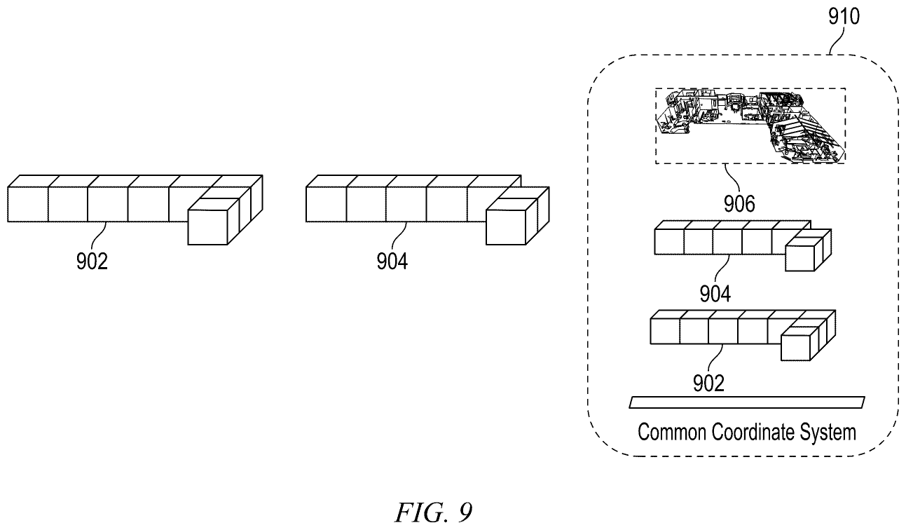

FIG. 9 illustrates a scenario in which the 3D representation system may access a first 3D representation 902 of an environment and a second 3D representation 904 of the environment. The first 3D representation 902 and the second 3D representation 904 may correspond to different versions of the environment, such as different stages of construction, different remodeling phases, or different capture sessions of the same location. The first 3D representation 902 and the second 3D representation 904 may also include at least some overlapping portions of the environment, such that the mesh geometry in the overlapping regions may differ based on structural or visual changes across time.

In various embodiments, the 3D representation system may generate a heat mesh 906 that depicts differences between the mesh of the first 3D representation 902 and the mesh of the second 3D representation 904. For example, the 3D representation system may compare the vertices, surfaces, textures, or other mesh elements of the first 3D representation 902 to the corresponding vertices, surfaces, textures, or other mesh elements of the second 3D representation 904. Based on the comparison, the 3D representation system may assign colors or other visual indicators to portions of the heat mesh 906 to represent the degree or nature of the differences. Areas that differ substantially between the two source meshes may be represented with one set of colors, while areas that differ only slightly or not at all may be represented with another.

In some embodiments, the 3D representation system may generate a group 910 that includes the first 3D representation 902, the second 3D representation 904, and the heat mesh 906. Grouping the first 3D representation 902, the second 3D representation 904, and the heat mesh 906 may allow a user to compare the visual differences between the two 3D representations and to navigate among them while maintaining alignment relative to a common coordinate system. In such workflows, the heat mesh 906 may be used to visualize structural changes, environmental modifications, or temporal differences that occurred between the capture associated with the first 3D representation 902 and the capture associated with the second 3D representation 904. In some embodiments, the first 3D representation 902, the second 3D representation 904, and the heat mesh 906 are aligned prior to being grouped.

In various embodiments, the 3D representation system may utilize the heat mesh 906 to assist with inspection, auditing, remodeling assessment, or progress-tracking tasks. Because the heat mesh 906 highlights differences between the two source meshes, a user may identify how a particular region of the environment has changed over time, such as the installation or removal of walls, fixtures, or other structural elements. FIG. 9 therefore depicts a scenario in which the 3D representation system may generate a heat mesh 3D representation that conveys mesh-level differences between multiple 3D representations of an environment.

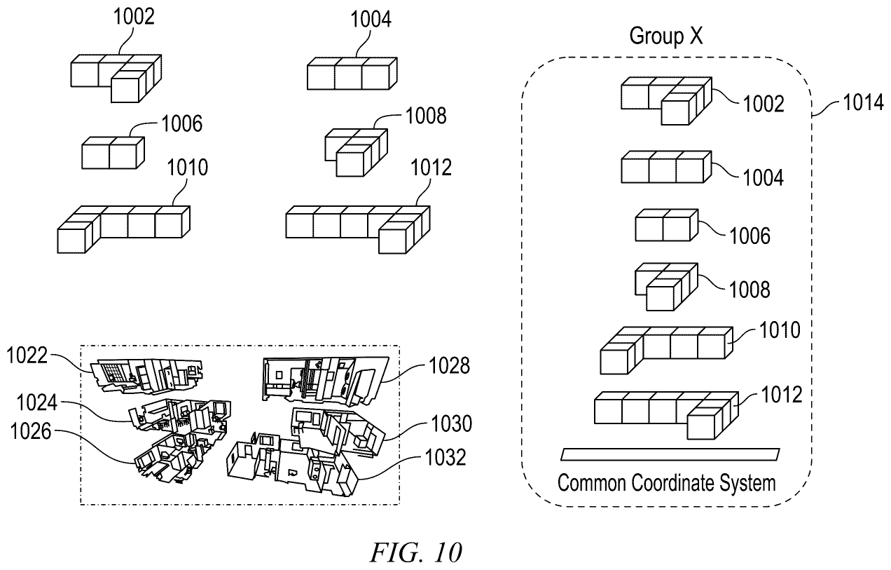

FIG. 10 illustrates a scenario in which the 3D representation system may access multiple 3D representations of portions of an environment that are physically separated from one another. As depicted in FIG. 10, the 3D representation system may access a first 3D representation 1002 (also shown as first 3D representation 1022), a second 3D representation 1004 (also shown as second 3D representation 1024), a third 3D representation 1006 (also shown as third 3D representation 1026), a fourth 3D representation 1008 (also shown as fourth 3D representation 1028), a fifth 3D representation 1010 (also shown as fifth 3D representation 1030), and a sixth 3D representation 1012 (also shown as sixth 3D representation 1032). The 3D representations may correspond to different units located at the same overall site, such as separate apartments within an apartment complex, separate rooms within a multi-building facility, or other physically distinct but related portions of an environment. Because the 3D representations correspond to different physical locations, the 3D representations may not overlap and may reflect distinct interior layouts or structural features, even though the 3D representations belong to the same overall site.

In various embodiments, the 3D representation system may generate a group 1014 that includes the first 3D representation 1002, the second 3D representation 1004, the third 3D representation 1006, the fourth 3D representation 1008, the fifth 3D representation 1010, and the sixth 3D representation 1012. Grouping the 3D representations may allow the 3D representation system to organize the physically separated portions of the environment into a unified collection. For example, grouping may allow a user to explore each of the 3D representations as part of a broader set of related units, such as viewing multiple apartments within a building or multiple facilities within a campus. Although the first 3D representation 1002, the second 3D representation 1004, the third 3D representation 1006, the fourth 3D representation 1008, the fifth 3D representation 1010, and the sixth 3D representation 1012 are physically distinct, the 3D representations may be positioned or oriented relative to a common coordinate system to assist users in understanding their relationships within the larger environment. In some embodiments, the first 3D representation 1002, the second 3D representation 1004, the third 3D representation 1006, the fourth 3D representation 1008, the fifth 3D representation 1010, and the sixth 3D representation 1012 are aligned prior to being grouped.

In some embodiments, grouping the first 3D representation 1002, the second 3D representation 1004, the third 3D representation 1006, the fourth 3D representation 1008, the fifth 3D representation 1010, and the sixth 3D representation 1012 may facilitate uses in which a user may switch between the units or locations represented by the 3D representations while maintaining context within the group 1014. For example, a user may explore one 3D representation corresponding to a first apartment and then seamlessly transition to another 3D representation corresponding to a second apartment, even though the two apartments do not share physical adjacency. Grouping may also allow users to compare features across multiple units, manage annotations across the set, or create coordinated viewing experiences without merging the physically separated 3D representations into a single 3D representation.

In various embodiments, the 3D representation system may preserve the distinctness of the first 3D representation 1002, the second 3D representation 1004, the third 3D representation 1006, the fourth 3D representation 1008, the fifth 3D representation 1010, and the sixth 3D representation 1012 while still enabling unified navigation, visualization, or editing operations across the group 1014. This arrangement may support use cases such as property portfolio review, multi-unit facility management, or inspection of multiple separated areas within a single site. Accordingly, FIG. 10 depicts a scenario in which multiple 3D representations that correspond to distinct physical portions of an environment may be grouped to allow a user to explore them as a related collection.

For large sites that include a combination of adjacent and separated buildings, some with or without outdoor connectivity, the 3D representation system may access multiple 3D representations that correspond to different portions of an environment and generate a group that organizes those 3D representations into a unified collection. For example, a campus may include dozens or hundreds of building or outdoor 3D representations distributed across a large geographic area. The 3D representation system may generate a group that includes the building or outdoor 3D representations and may position or orient the building or outdoor 3D representations relative to a common coordinate system. This grouping may allow a user to explore related building or outdoor 3D representations as one collection, even when the building or outdoor 3D representations are physically separated from each other or are only connected via outdoor paths.

In various embodiments, the 3D representation system may align the grouped building or outdoor 3D representations using geospatial hints, outdoor adjacency, or user-provided placement within the site, and may preserve each building or outdoor 3D representation as a distinct digital construct within the group. The grouping may enable seamless transitions between neighboring buildings, selective navigation to non-adjacent buildings, and coordinated visualization or comparison across the site without requiring the building or outdoor 3D representations to be merged into a single 3D representation. As a result, the 3D representation system may support large-scale workflows such as campus operations, multi-building inspections, or portfolio review while maintaining per-building editability and performance characteristics that are suitable for large collections.

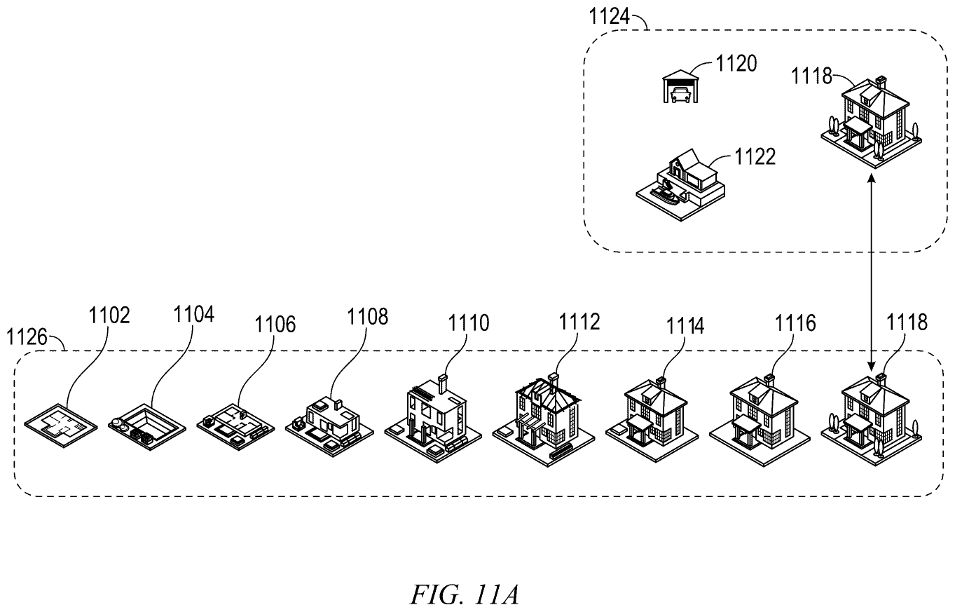

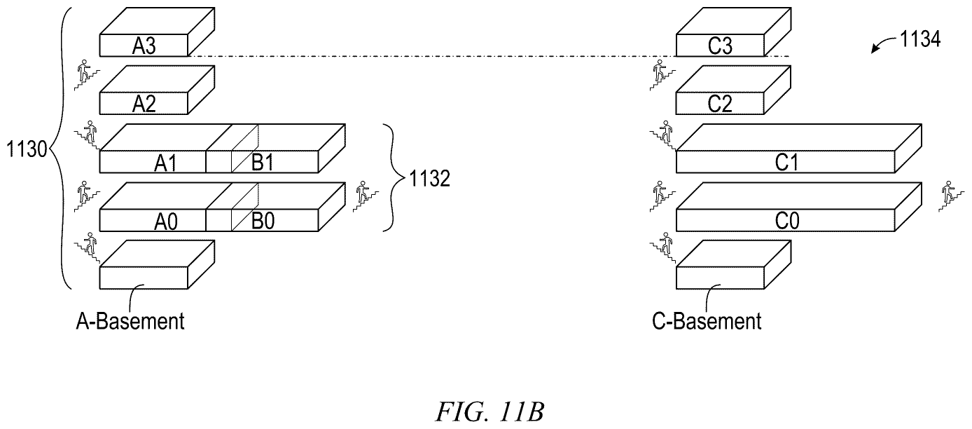

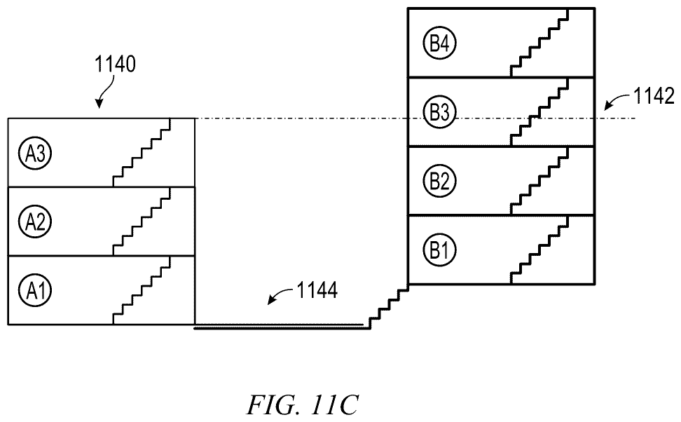

FIG. 11A illustrates a scenario in which the 3D representation system may generate a group 1124 of multiple 3D representations corresponding to portions of an environment. As depicted, the group 1124 includes a first 3D representation 1118 for a house, a second 3D representation 1120 for a garage, and a third 3D representation 1122 for a boat house. Within the group 1124, the first 3D representation 1118 is linked to a group 1126 that includes a 3D representation 1102 through a 3D representation 1118 that together represent different stages or variants of the house, enabling a user to view progress over time or compare configurations.

Although the 3D representation 1120 and the 3D representation 1122 may not share physical adjacency with the house, grouping them with the related 3D representation 1102 through the 3D representation 1118 may allow a user to explore the house and then transition to the garage or the boat house as part of a unified collection. This arrangement supports a workflow in which a user can review progress of the house over time while also viewing related structures that are part of the same site.

In some embodiments, the 3D representation system may embed links in the 3D representation 1118 that allow a user to navigate directly to the 3D representation 1120 for the garage or the 3D representation 1122 for the boat house, and to navigate back to the 3D representation 1118. These links may be presented as user-selectable elements that, when activated, cause the 3D representation system to load the target 3D representation while preserving spatial context and alignment rules defined for the group 1124. By leveraging such links, a user may move among the 3D representation 1118 for the house, the 3D representation 1120 for the garage, and the 3D representation 1122 for the boat house without leaving the grouped experience.

The 3D representation system may align the 3D representations in the group 1124 relative to a common coordinate framework or site layout, so that transitions between the first 3D representation 1118 and the second 3D representation 1120 or the third 3D representation 1122 maintain an intuitive sense of location within the larger environment. The 3D representation system may similarly align the 3D representations in the group 1126. Accordingly, FIG. 11A depicts how a 3D representation that reflects a house stage (the 3D representation 1118) can be linked within a broader group of house stages (3D representation 1102 through 3D representation 1118) while also providing navigation to distinct 3D representations for the garage and boat house (3D representation 1120 and 3D representation 1122, respectively), thereby supporting time travel, comparison, and multi-structure exploration in a single grouped experience. In some embodiments, the 3D representation system may align the 3D representations in the group 1124 prior to grouping the 3D representations or may align the 3D representations in the group 1126 prior to grouping the 3D representations.

FIG. 11B illustrates a scenario in which the 3D representation system may access multiple 3D representations of an environment that include both vertical and horizontal overlap. As depicted, a first 3D representation 1130 includes five floors that are vertically connected via scanned stairs, and a second 3D representation 1132 includes two floors that are also vertically connected via different scanned stairs. In addition to these vertical connections, there is horizontal overlap between floors of the first 3D representation 1130 and corresponding floors of the second 3D representation 1132, indicating that portions of the same floors were captured in both 3D representations.

In various embodiments, the 3D representation system may utilize the vertical connections within the first 3D representation 1130 and the second 3D representation 1132, along with the horizontal overlap between corresponding levels, to align the two 3D representations. For example, the 3D representation system may identify stair runs and landings within each 3D representation to establish consistent vertical relationships for the levels, while also using overlapping same-level regions to refine horizontal positioning. These features may serve as structural cues that assist the 3D representation system in determining how the two 3D representations should be positioned relative to a common coordinate system prior to merging.

After alignment, the 3D representation system may merge the first 3D representation 1130 and the second 3D representation 1132 to generate a third 3D representation 1134. The third 3D representation 1134 may combine at least substantially all of the non-overlapping portions of the first 3D representation 1130 and the second 3D representation 1132, while resolving the horizontally overlapping regions at the same levels and preserving continuous vertical connectivity derived from the scanned stairs. In some embodiments, the 3D representation system may blend textures or otherwise harmonize mesh elements in the overlapping areas to provide smooth transitions across the merged levels.

In some embodiments, the 3D representation system may retain metadata indicating which portions of the third 3D representation 1134 originated from the first 3D representation 1130 or from the second 3D representation 1132. Such information may facilitate subsequent inspection or editing, for example, by allowing a user to review how the vertically connected stair segments were integrated across levels or how the horizontally overlapping same-level regions were reconciled in the merged result.

FIG. 11C illustrates a scenario in which the 3D representation system may access a first 3D representation 1140 corresponding to a multi-floor building and a second 3D representation 1142 corresponding to another multi-floor building that is physically separate from the first building. The floors of the first 3D representation 1140 are vertically connected via scanned stairs, and the floors of the second 3D representation 1142 are vertically connected via scanned stairs. The first 3D representation 1140 and the second 3D representation 1142 depict distinct structures within the same broader environment, with buildings that may not initially share a unified frame of reference and that are at two different absolute elevations. As shown, there exists an overlap 1144 that is a walkable area between regions associated with the first 3D representation 1140 and the second 3D representation 1142, providing a physical transition that may be used for alignment.

In various embodiments, the 3D representation system may utilize the overlap 1144 to align the first 3D representation 1140 and the second 3D representation 1142. The 3D representation system may identify contiguous ground surfaces, outdoor paths, or similar traversable regions that indicate how the buildings relate to each other within the environment. By using the overlap 1144 as a constraint, the 3D representation system may position the first 3D representation 1140 and the second 3D representation 1142 relative to a common coordinate system while maintaining correct relative elevations and building-specific floor structures.

After alignment, the 3D representation system may merge the first 3D representation 1140 and the second 3D representation 1142 to generate a third 3D representation (not depicted in FIG. 11C). The third 3D representation may include seven floors, with three floors specific to the building represented by the first 3D representation 1140 and four floors specific to the building represented by the second 3D representation 1142. In some embodiments, the 3D representation system may preserve per-building floor naming or metadata to indicate the source of each floor within the merged configuration, while ensuring that the walkable area forms a coherent connection between the buildings.

In additional embodiments, the 3D representation system may harmonize visual and geometric transitions where the walkable area meets each building, such as blending textures across the outdoor region or reconciling small elevation differences. This approach may allow a user to navigate continuously across the third 3D representation from the first building to the second building through the walkable overlap while still recognizing that certain levels belong to the first building and other levels belong to the second building.

### Aligning 3D Representations

As discussed herein, the 3D representation system may align 3D representations. Various techniques for aligning 3D representations are discussed herein. The 3D representation system may align 3D representations so that the aligned 3D representations may be combined, such as merged or grouped, and presented together, either as a single 3D representation or as multiple grouped 3D representations.

The 3D representation system may align 3D representations of different types. For example, the 3D representation system may align a Gaussian splat representation of an environment that includes a building with a 3D mesh representation of the building, such as the building interior. The 3D representation system may then display the two aligned 3D representations so that a user may navigate seamlessly between the two 3D representations. For example, the user may start by viewing the Gaussian splat representation of the environment. The user may navigate in the Gaussian splat representation by moving a virtual camera in the Gaussian splat representation. The user may move the virtual camera towards the building to cause the 3D representation system to reveal a portion of the 3D mesh representation of the building interior. The user may then move the virtual camera into the building interior, and the 3D representation system may transition to displaying the 3D mesh representation of the building interior without displaying the Gaussian splat representation. Described herein are techniques for aligning 3D representations so that these and other interactions with aligned 3D representations are possible.

For a 3D representation that includes a 3D mesh, the 3D representation system may have many scan locations, each with a 3D position in the 3D mesh and also GPS data. The 3D representation system may determine an overall geolocation (for example, latitude, longitude, orientation) for the 3D mesh via a best-fit of the GPS data across the scan locations while maintaining their relative locations in the mesh. The 3D representation system may weight each scan location's GPS data more or less strongly based on GPS reliability data at that location. The 3D representation system may also use robust fitting methods, such as discarding outliers. The 3D representation system may also include other location data beyond the GPS data (which may come from a capture system 104), such as location services data from the capture control system 106 or a user-entered location. Additional location information (accelerometer, magnetometer, barometer) may be used in determining the scan locations within the 3D mesh and could potentially be used for geolocation as well.

For a 3D representation that includes Gaussian splats, the 3D representation system may also have many photo locations, each with a 3D position relative to the Gaussian splats and GPS data. The 3D representation system may perform a similar process to find an overall geolocation of the splat representation. In some embodiments, the 3D representation system may receive an altitude that is captured by a capture system 104, such as an aerial drone. In some embodiments, the 3D representation system may have GPS data for each photo captured by the capture systems 104. Additionally or alternatively, the 3D representation system may receive geolocation attached to the processed Gaussian splat representation.

The 3D representation system may initialize the alignment between the 3D mesh and the Gaussian splats using the overall geolocation of each 3D representation. If the 3D representation system has the two locations relative to a common reference (geolocation relative to the earth), the 3D representation system may determine their location relative to each other. However, in some cases, the 3D representation system may not have the altitude for the 3D mesh. When the 3D representation system does not have the altitude for the 3D mesh, the 3D representation system may perform an extra step to determine absolute or relative altitude. To do that, if the 3D mesh includes scans of the ground outside the building, the 3D representation system may locate the ground level separately in each representation and then choose an altitude for the 3D mesh that makes the 3D mesh ground level match the Gaussian splats' ground level. If the 3D mesh doesn't include any of the ground outside the building, the 3D representation system may utilize heuristics such as setting the floor level of one of the building floors (the lowest, or the ground floor if the 3D representation system has information about which is the ground floor) equal to or with a standard offset from the exterior ground level detected in the Gaussian splats. The 3D representation system may also identify the general altitude of the building in the Gaussian splats and choose an altitude for the 3D mesh that fits within that exterior shape as accurately as possible.

These techniques may result in a good initial alignment between the Gaussian splats and 3D mesh, but the initial alignment may have certain deficiencies. To refine the initial alignment, the 3D representation system may utilize one or more of several techniques. One technique is to run an iterative closest point (ICP) algorithm or some other distance-minimization algorithm between corresponding geometric features of the Gaussian splat representation and the 3D mesh. In some cases, the 3D mesh may include scans of some outdoor areas (ground or building exterior). In such cases, the 3D representation system may find correspondences between those same surfaces in each 3D representation. The 3D representation system may align ground to ground, exterior walls to exterior walls, and so forth. Another approach that the 3D representation system may utilize relates to matching features that are expected to be identifiable on both the inside and outside of the building, such as doors and windows, though also potentially wall surfaces in general (accounting for wall thickness). The 3D representation system may identify the locations and shapes of doors and windows in both the interior 3D mesh and the exterior Gaussian splats. The 3D representation system may then propose an alignment based on finding correspondences between those features. One advantage of this technique is that doors and windows may also provide a tight match for altitude, so they could be used directly without requiring an altitude alignment step, or potentially even skipping an initial GPS initialization as long as the 3D representation system can identify the building of interest in the Gaussian splat representation.

To match corresponding features, the 3D representation system may filter each 3D representation to only the regions where the 3D representation system expects to have correspondences between the 3D representations. For example, the 3D representation system may filter out the 3D mesh corresponding to the inside of the building and filter out the Gaussian splats corresponding to the rest of the environment and only keep the portion of the Gaussian splats that represents the building. One way of doing this filtering would be via semantic segmentation, where the 3D representation system may assign semantic classes (grass, roof, door, etc.) to portions of each 3D representation and then align using this information. Additionally or alternatively, the 3D representation system may perform semantic segmentation where the 3D representation system only includes certain classes from each 3D representation. Additionally or alternatively, the 3D representation system may choose correspondences between the 3D representations that account for this semantic labeling, or the 3D representation system may use the semantic information internally to the alignment algorithm such as by weighting correspondences higher if they also have matching semantic classes.

Another option for refining the alignment (instead of or in addition to the above) is to use derived building data from the 3D mesh representation (and its associated data), such as room boundaries. If the 3D mesh only represents the interior of the building and the Gaussian splats only represent the exterior, the 3D representation system may infer an exterior shape of the building from the 3D mesh or room boundaries, including adjustment for the exterior wall thickness. The 3D representation system may then align the geometry of this extrapolated building exterior shape with the building exterior directly observed in the Gaussian splats. The 3D representation system may even solve for the potentially unknown exterior wall thickness during this alignment.

The 3D representation system may identify connection points by identifying similar features within two or more 3D representations. For example, the 3D representation system may identify connection points by recognizing paths, stairways, doorways, or other features and align 3D representations using these features. As another example, the 3D representation system may identify features in 2D or 3D images of 3D representations, match features, and utilize the matched features to align 3D representations. As another example, the 3D representation system may utilize artificial intelligence or machine learning models to align 3D representations. The 3D representation system may provide 2D or 3D images of 3D representations to the artificial intelligence or machine learning models to determine absolute or relative positions of the images and utilize the absolute or relative position of the 2D or 3D images to align 3D representations. It will be understood that the 3D representation system may utilize other techniques to align 3D representations.

In addition to or as an alternative to automatic alignment of 3D representations, the 3D representation system may also generate or refine the alignment with the help of user input. The 3D representation system may show the two 3D representations together in a 3D viewer (composer) with a visualization that lets the user see how the two 3D representations are positioned relative to each other (for example, with transparency so the user can see both versions at once). The user may then provide input about how to adjust the alignment, including manual controls such as dragging or rotating one 3D representation, or tool-assisted alignment such as selecting point(s) in one 3D representation and corresponding point(s) in the other 3D representation and then the tool adjusts the alignment to bring those correspondences together. For single-point selections, this could snap both position and normal of the single correspondence pair. Another user input option is for the user to partially refine the alignment (for example, drag the 3D representations closer together) and then trigger a tool that automatically refines the alignment per above, this time with better initialization to improve its chances of success. Additionally or alternatively, a user may define a new doorway or a new position, or identify a location with a 3D representation to position or connect another 3D representation.

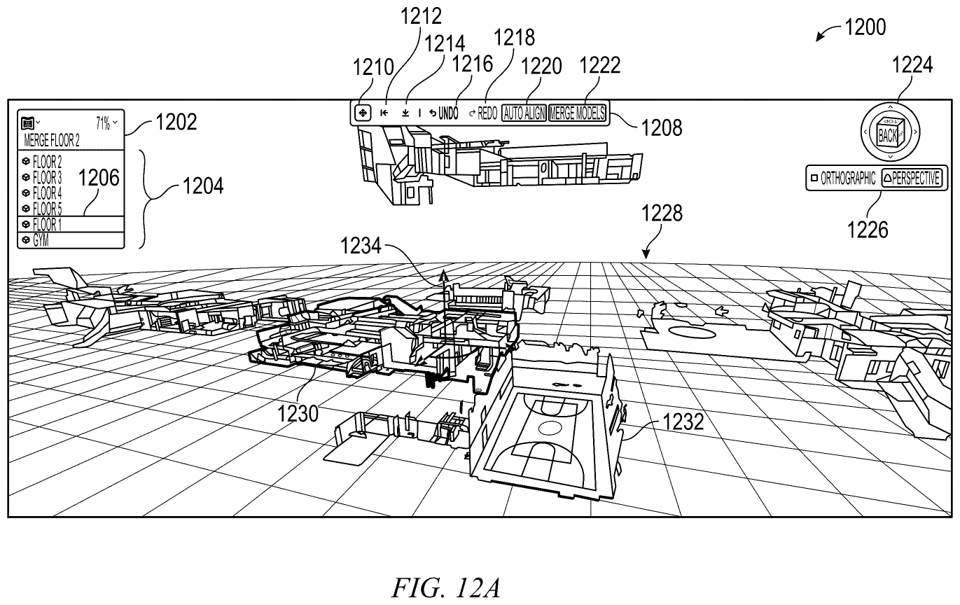

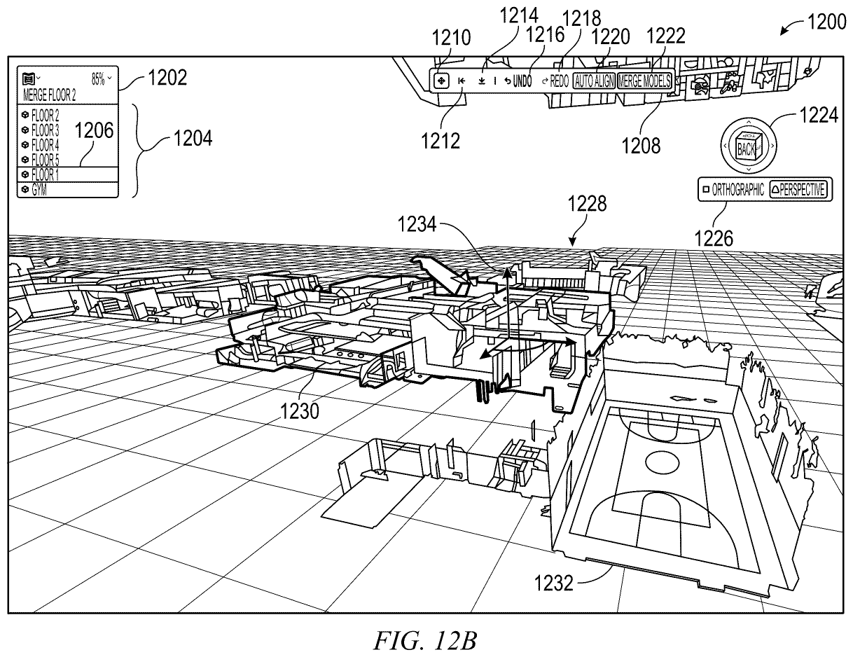

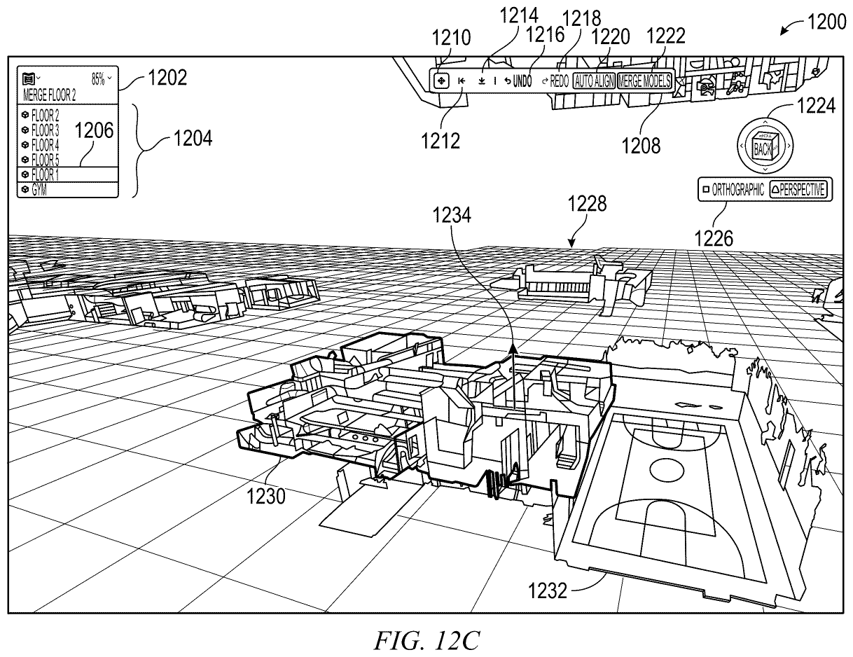

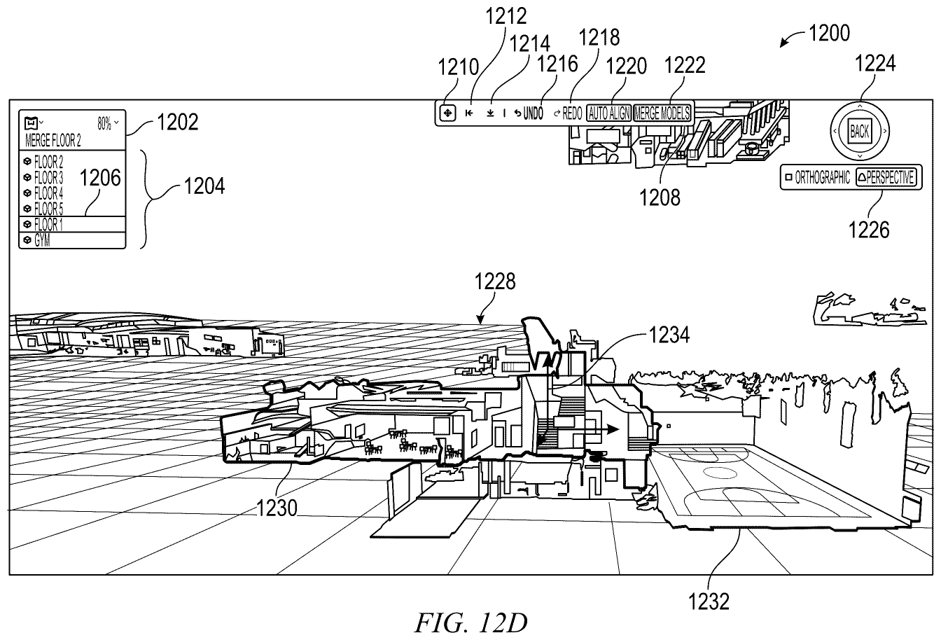

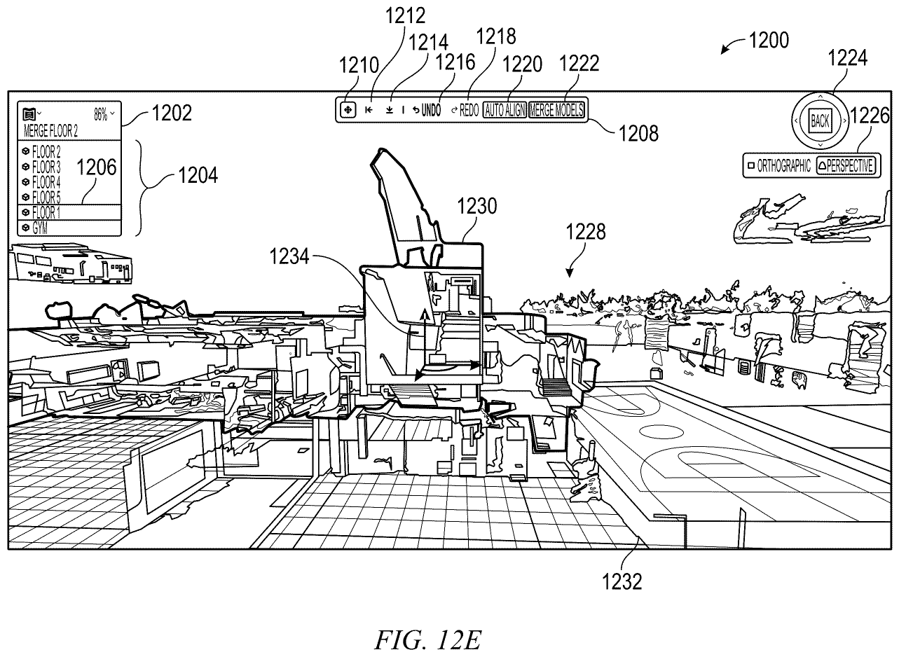

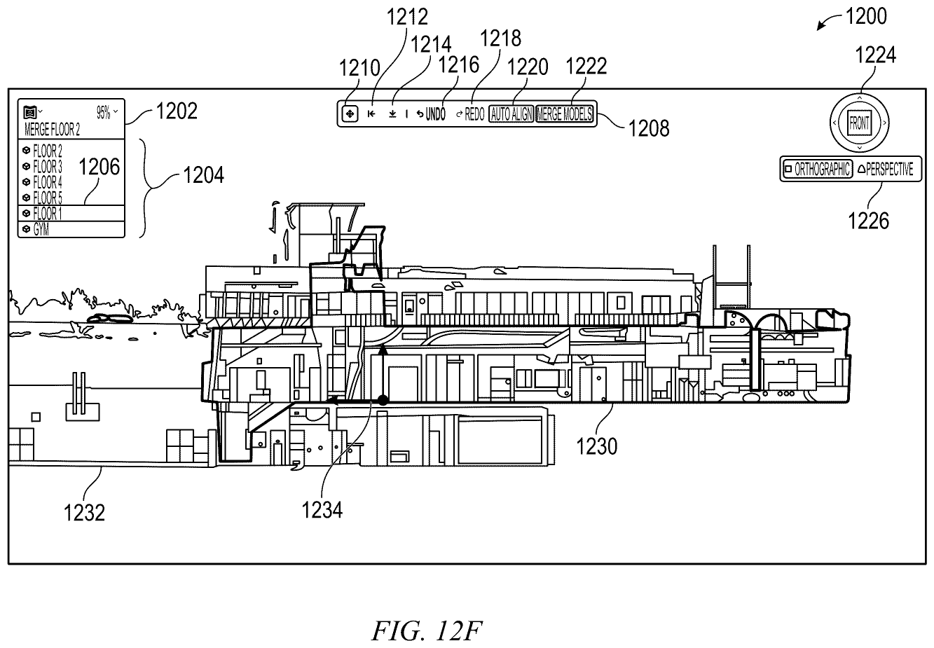

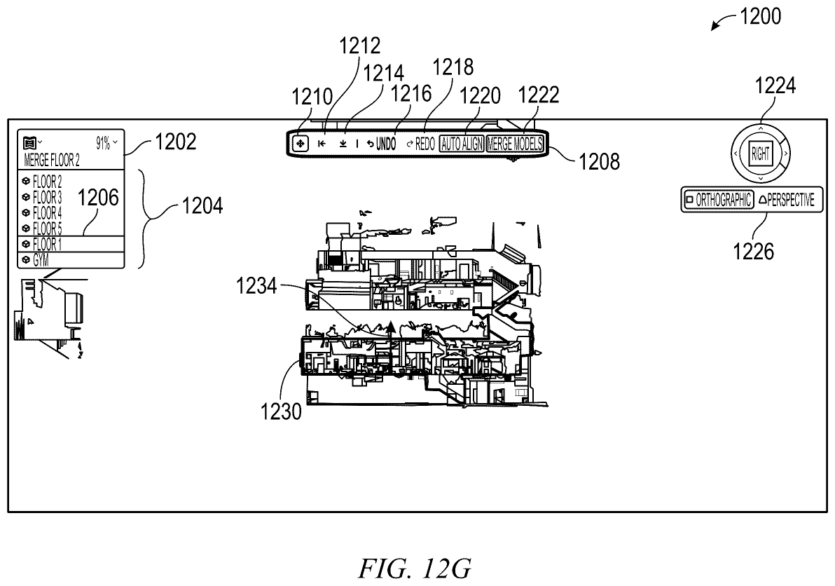

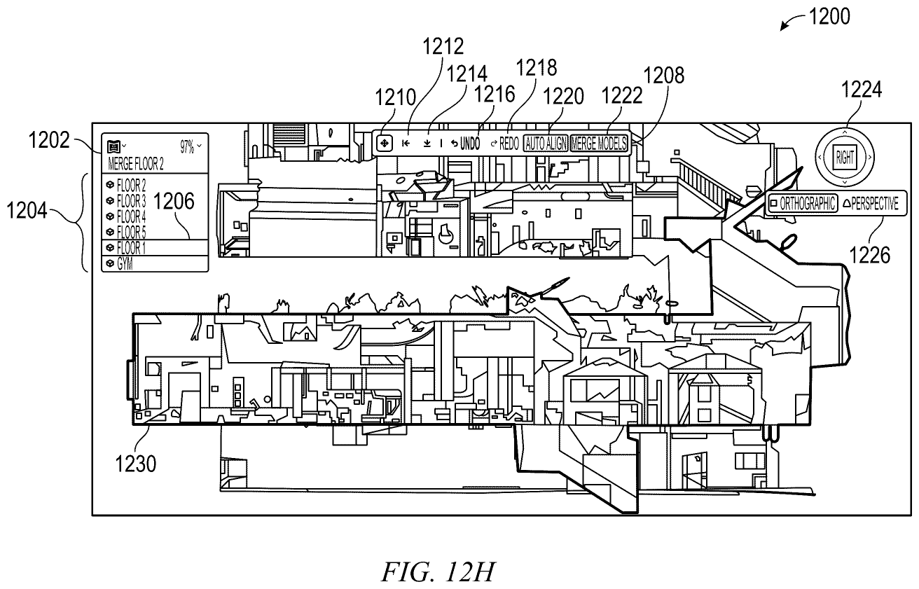

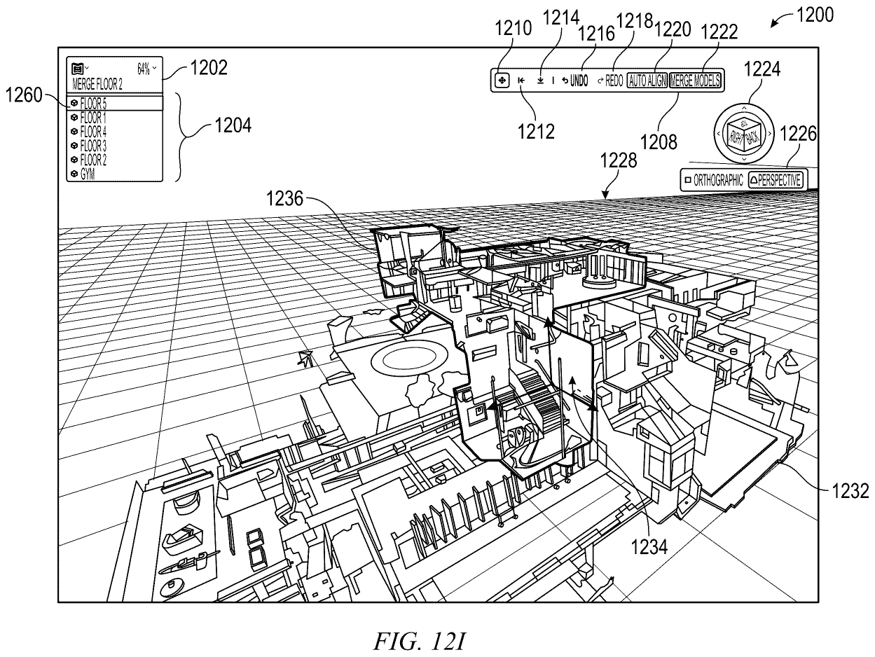

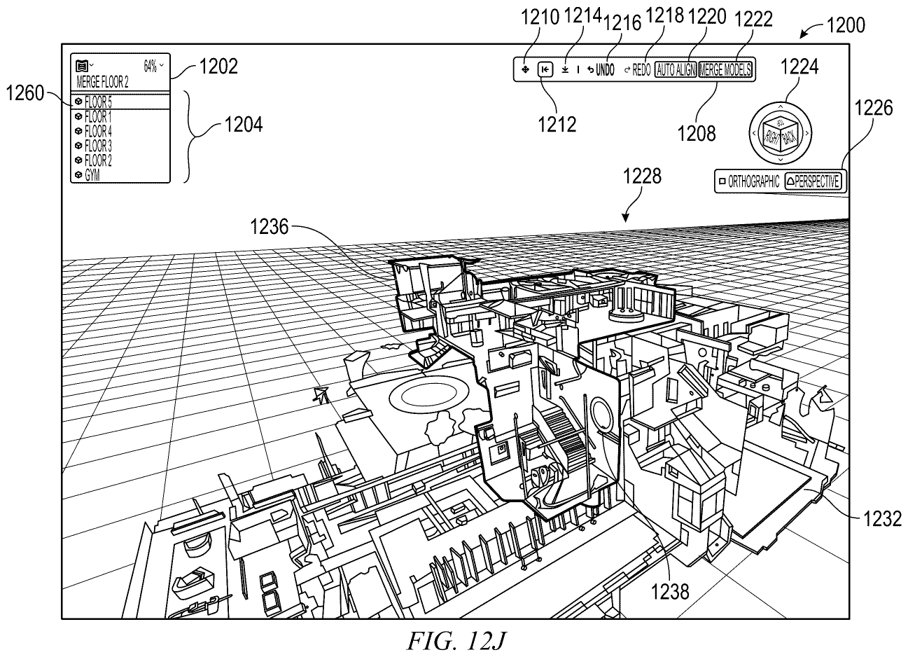

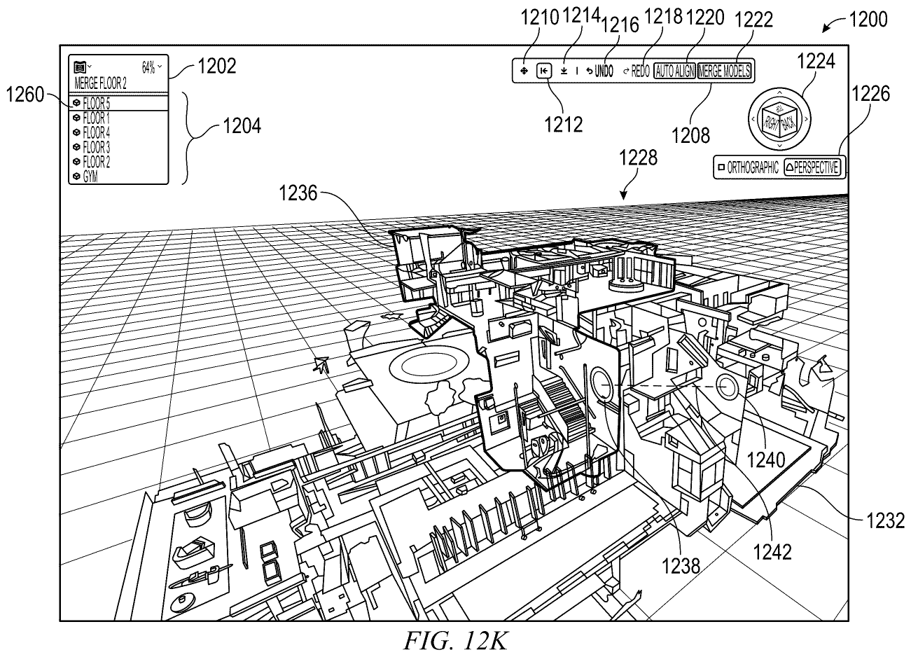

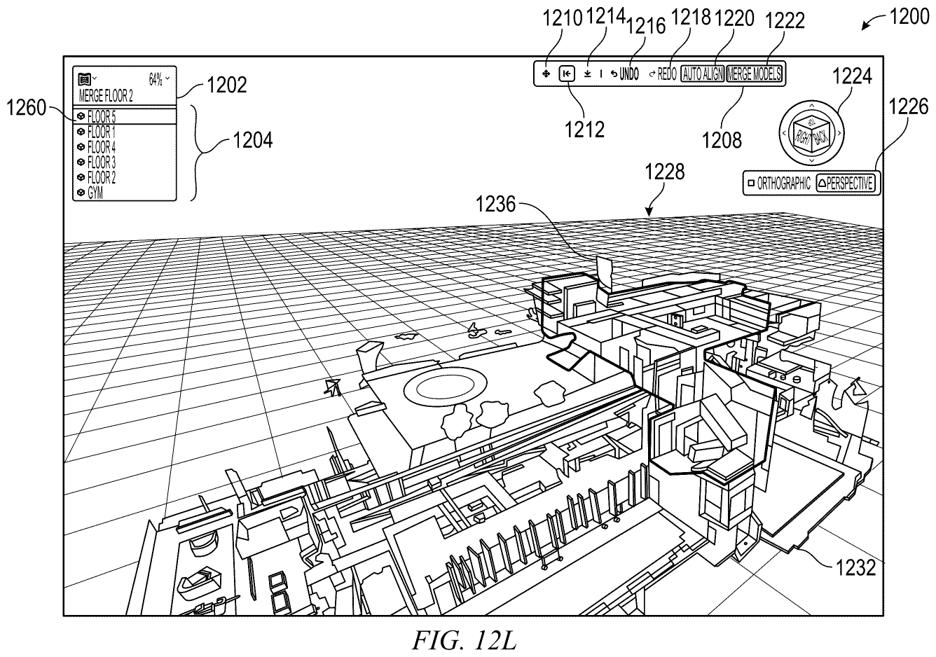

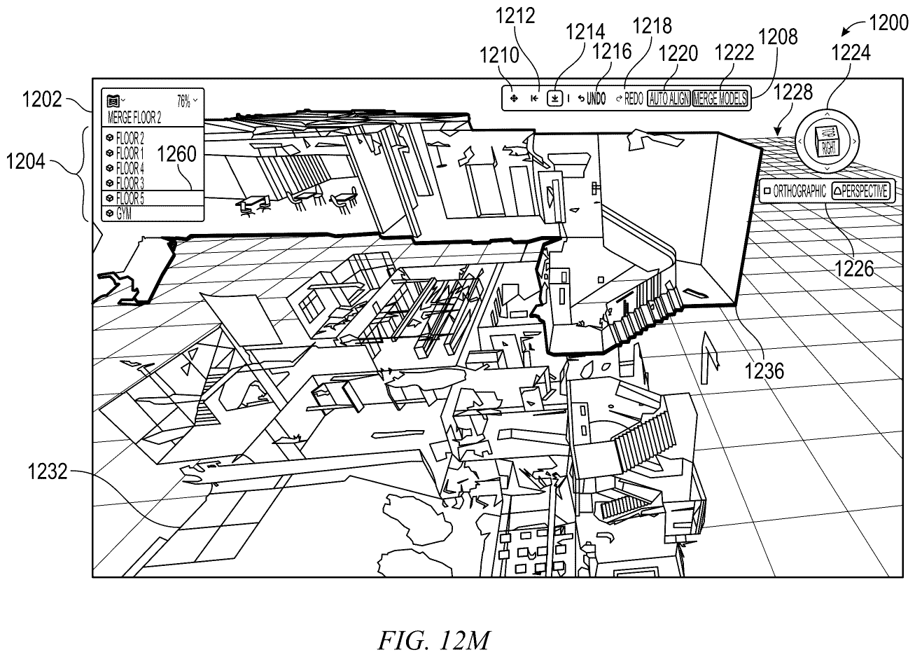

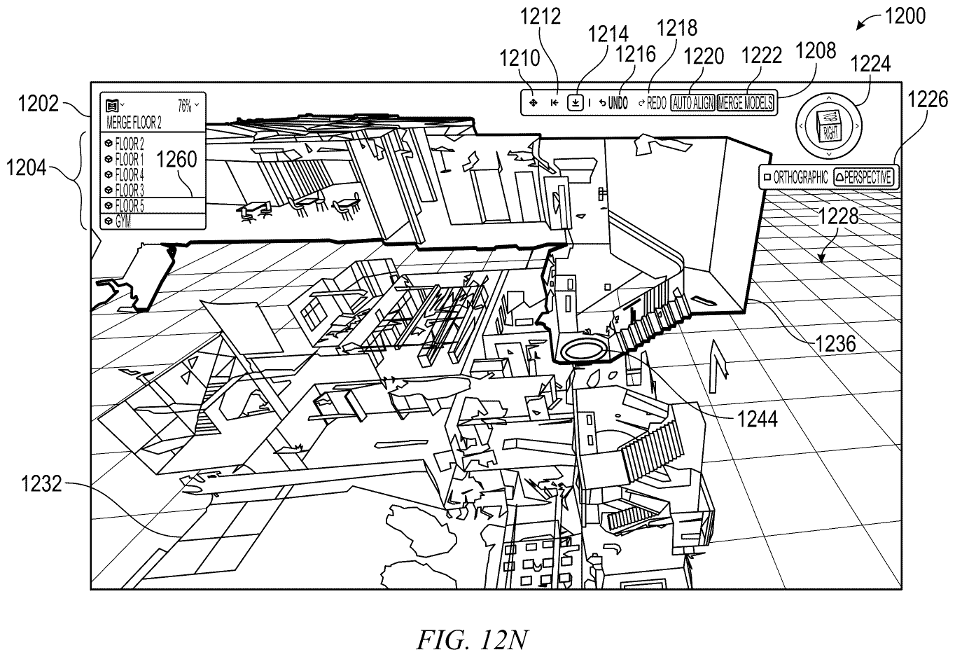

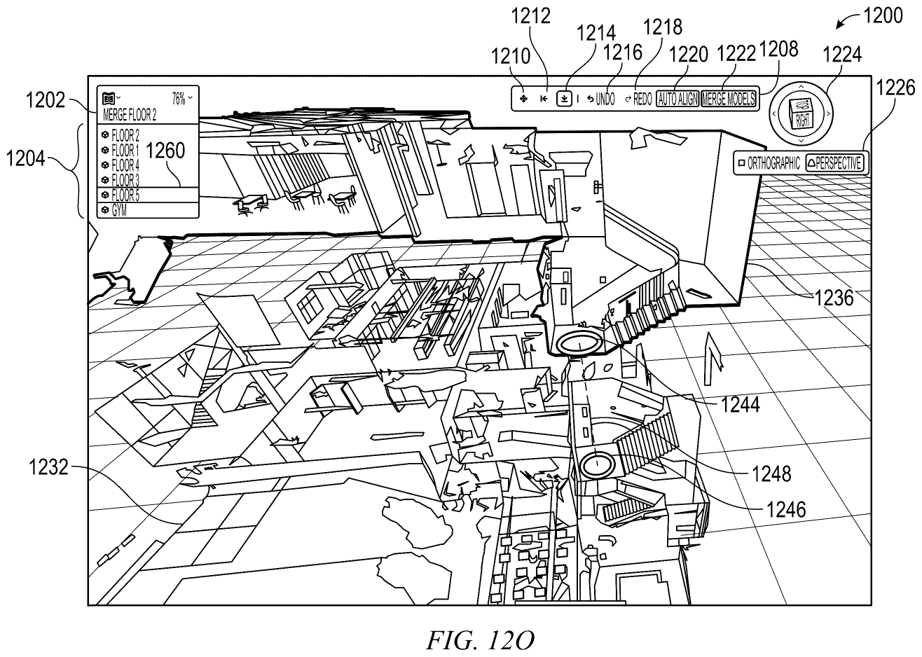

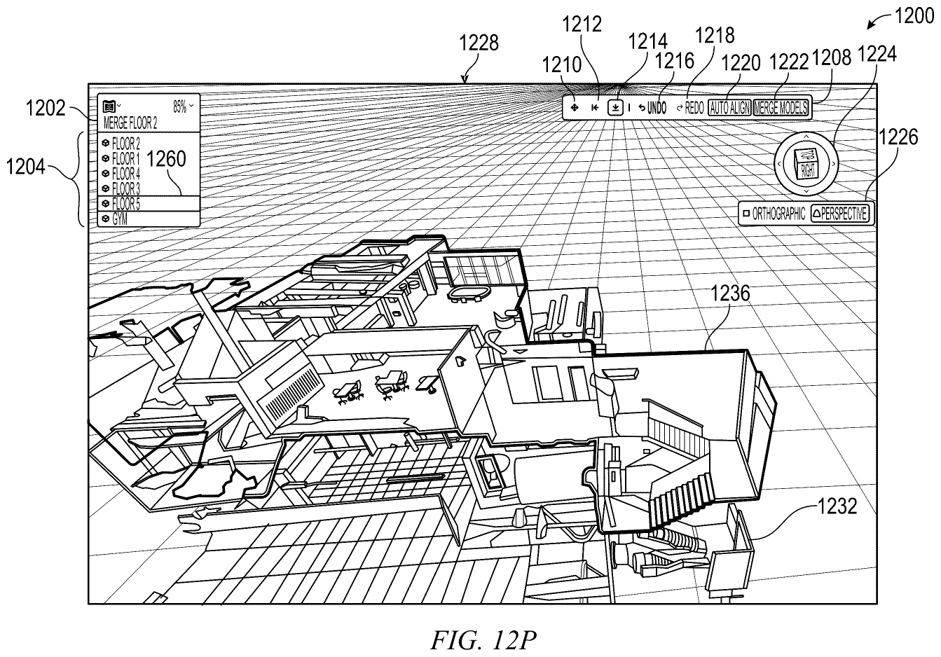

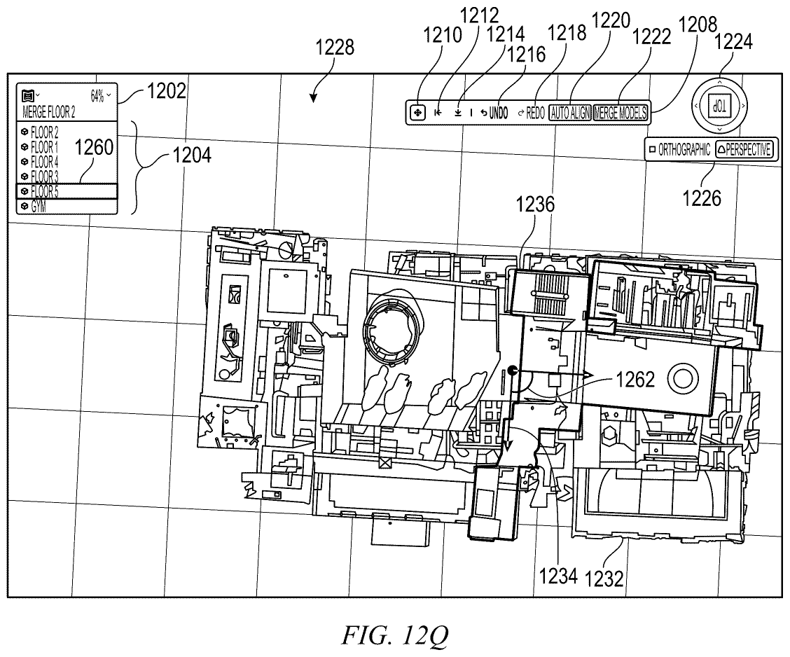

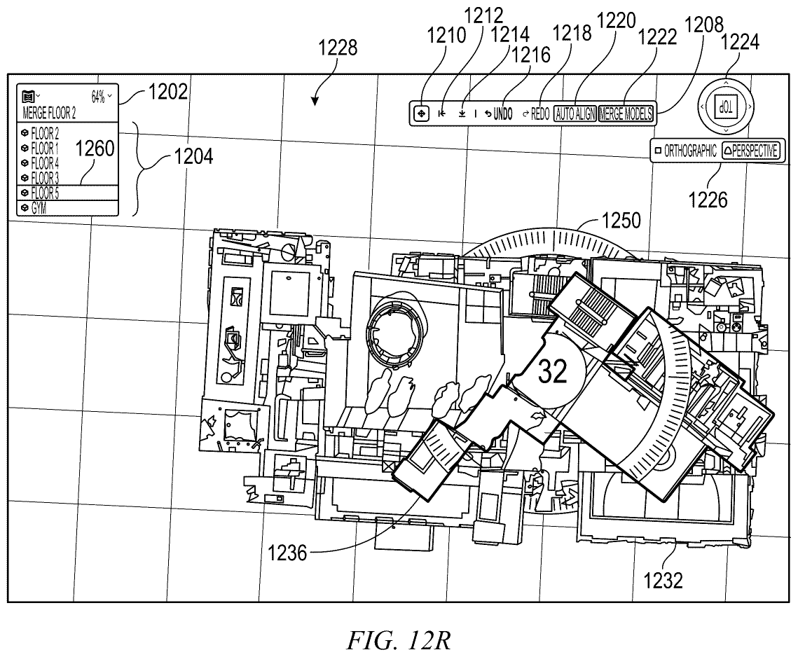

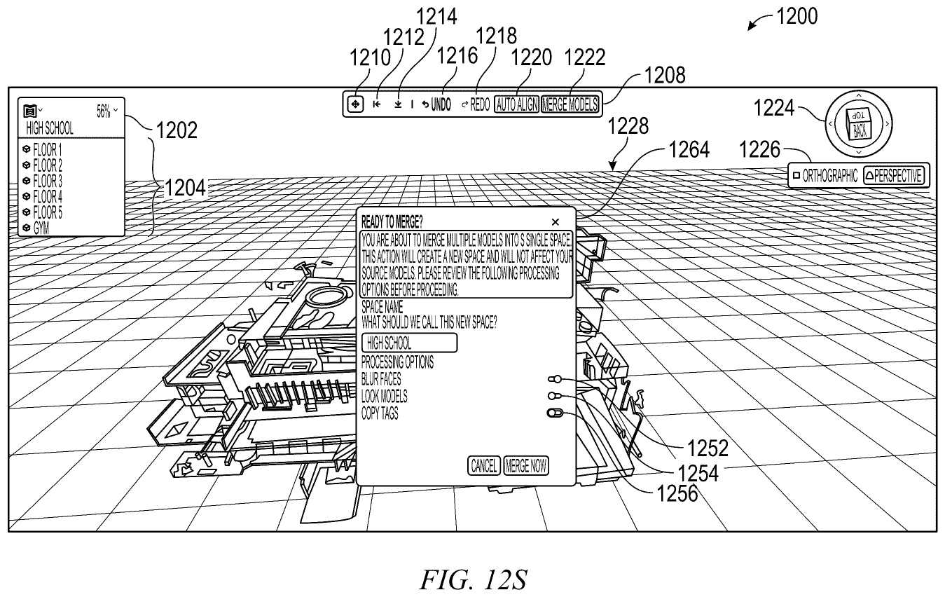

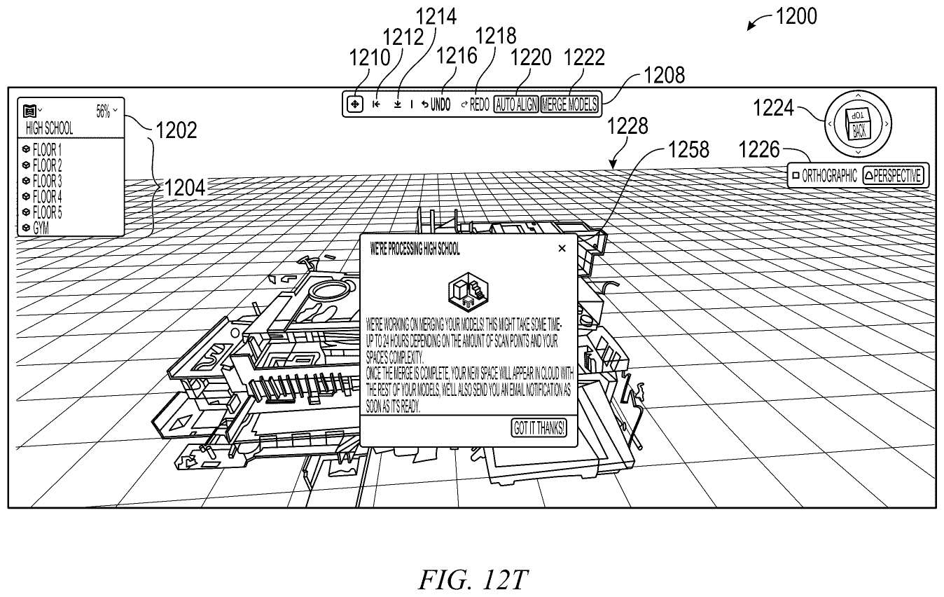

FIGS. 12A-12T depict an example interface 1200 for combining 3D representations that may be provided by a 3D representation system according to some embodiments. The interface 1200 may be provided by, for example, a presentation component 112 that is executing on a presentation system 110 that includes a desktop or a laptop computing device. A user may utilize the interface 1200 to align 3D representations prior to the 3D representations being combined. The interface 1200 includes a region 1228 for displaying 3D representations, such as 3D representation 1230 and 3D representation 1232. The interface 1200 also includes a 3D representation selector 1202, a toolbar 1208, an orientation widget 1224, and a view selector 1226. The 3D representation selector 1202 displays names 1204 of 3D representations. A user may select one of the names 1204 to select a 3D representation displayed in the region 1228. As depicted in FIG. 12A, name 1206 is selected, corresponding to 3D representation 1230. Accordingly, the 3D representation 1230 is depicted as selected in the region 1228. The 3D representation 1230 may be selected in order to align the 3D representation 1230 with the 3D representation 1232.

The toolbar 1208 includes numerous tools for manipulating 3D representations, such as a move tool 1210, a wall magnet tool 1212, and a floor magnet tool 1214. The user may select the move tool 1210 to move a selected 3D representation. Upon selection of the move tool 1210, the interface 1200 displays a move element 1234 that includes three axes, each with an arrow, corresponding to an x-axis, a y-axis, and a z-axis. The user may select an arrow to move a 3D representation in directions along that axis. For example, the user may select an arrow and hold the arrow to move the 3D representation along that plane and then drag the user's mouse in the direction that the user wants the 3D representation to move. The user may select the arrow that points to the right to move the 3D representation left and right, select the arrow that points up to move the 3D representation up and down, or select the arrow that points towards the user to move the 3D representation towards and away from the user.

The user may select the wall magnet tool 1212 to select wall surfaces or structures that are common to two 3D representations and attempt to align the two 3D representations based on the selected wall surfaces or structures. The user may select the floor magnet tool 1214 to select floor surfaces or structures that are common to two 3D representations and attempt to align the two 3D representations based on the selected floor surfaces or structures. As discussed in more detail herein, the user may use the move tool 1210, the wall magnet tool 1212, or the floor magnet tool 1214 to move a 3D representation so that the 3D representation may be aligned with another 3D representation prior to the pair of 3D representations being merged. The toolbar 1208 also includes an undo button 1216 and a redo button 1218 that the user may select to undo or redo actions. The toolbar 1208 also includes an auto-align button 1220 that the user may select to request that the 3D representation system automatically align a 3D representation with one or more other 3D representations, and a merge models button 1222 that the user may select to request that the 3D representation system merge a 3D representation with one or more other 3D representations.

The orientation widget 1224 may display the orientation of a 3D representation displayed in the region 1228. The user may change the orientation of the 3D representation (for example, in 90-degree increments) by selecting an arrow in the orientation widget 1224. The view selector 1226 may allow the user to select an orthographic view or a perspective view of the 3D representations in the region 1228. The user may zoom in and out and the 3D representation selector 1202 may display a current zoom level. In some embodiments, the user may select a 3D representation using an input device (for example, a mouse) and move, rotate, or otherwise manipulate the 3D representation into an intended position or orientation.

In FIG. 12A, the move tool 1210 has been selected, and the move element 1234 is displayed in the region 1228 proximate to the 3D representation 1230. The 3D representation system may place the move element 1234 at a position to allow the user to select an arrow of the move element 1234. For example, the 3D representation system may place the move element 1234 at a position at a center of the interface 1200, at a position corresponding to a centroid of the 3D representation 1230, or at another suitable position, to move the 3D representation up and down. FIG. 12B depicts that the user has zoomed in closer to the 3D representation 1230 and has selected the arrow that points up of the move element 1234. Accordingly, the 3D representation system may constrain the movement of the 3D representation 1230 to vertical movement only. The user may select the 3D representation 1230 using an input device and move the 3D representation 1230 vertically only. FIG. 12C depicts that the user has moved the 3D representation 1230 down to be closer to the 3D representation 1232. FIG. 12D depicts that the user has zoomed out away from the 3D representation 1230 and has changed the view to see the back of the 3D representation 1230, as indicated by the orientation widget 1224.

FIG. 12E depicts that the user has zoomed in closer to the 3D representation 1230. FIG. 12F depicts that the user has changed the view to see the front of the 3D representation 1230, as indicated by the orientation widget 1224, and has used the view selector 1226 to change to an orthographic view. Utilizing orthographic or perspective views may help the user to see what changes the user may have to make in order to align the 3D representation 1230 with the 3D representation 1232. FIG. 12G depicts that the user has changed the view to see the right of the 3D representation 1230, as indicated by the orientation widget 1224. In some embodiments, the move element 1234 may display a selectable lock label or icon that the user may select to lock the position and orientation of a 3D representation so as to prevent the 3D representation from moving. FIG. 12H depicts that the user has zoomed in closer to the 3D representation 1230 and that the 3D representation 1230 is locked in place.

FIG. 12I depicts the interface 1200 where the user has selected another name, name 1260, from the names 1204. Accordingly, the 3D representation 1236 is depicted as selected in the region 1228. As the move tool 1210 is selected, the move element 1234 is displayed in the region 1228 proximate to the 3D representation 1236. FIG. 12J depicts that the user has selected the wall magnet tool 1212, and the move element 1234 is no longer displayed in the region 1228. The wall magnet tool 1212 allows the user to select one or more wall surfaces from one 3D representation and one or more wall surfaces from another 3D representation, so that the 3D representation system may utilize the selected wall surfaces to move one or both of the 3D representations so that the two 3D representations may be aligned. FIG. 12J depicts that the user has selected a first wall surface from 3D representation 1236, which is indicated by a first circle icon 1238. FIG. 12K depicts that the user has selected a second wall surface from 3D representation 1232, which is indicated by a second circle icon 1240. The region 1228 also displays a dashed line 1242 between the first circle icon 1238 and the second circle icon 1240, indicating that the two selected wall surfaces are to be used to move the 3D representation 1236 or the 3D representation 1232 so that the 3D representation 1236 and the 3D representation 1232 may be aligned. The user may request that the 3D representation system move the 3D representation 1236 or the 3D representation 1232, such as by selecting the dashed line 1242 or by selecting the wall magnet tool 1212. Alternatively, the 3D representation system may move the 3D representation 1236 or the 3D representation 1232 once the user selects the second wall surface. FIG. 12L depicts that the 3D representation 1236 has moved such that the two selected wall surfaces are aligned and the 3D representation 1236 is aligned with the 3D representation 1232.

The user may also use the floor magnet tool 1214 to select one or more floor surfaces from one 3D representation and one or more floor surfaces from another 3D representation, so that the 3D representation system may utilize the selected floor surfaces to move one or both of the 3D representations so that the two 3D representations may be aligned. FIG. 12M depicts the 3D representation 1236 positioned such that it is not aligned with the 3D representation 1232 and that the user has selected the floor magnet tool 1214. FIG. 12N depicts that the user has selected a first floor surface from 3D representation 1236, which is indicated by a first circle icon 1244. FIG. 12O depicts that the user has selected a second floor surface from 3D representation 1232, which is indicated by a second circle icon 1246. The region 1228 also displays a dashed line 1248 between the first circle icon 1244 and the second circle icon 1246, indicating that the two selected floor surfaces are to be used to move the 3D representation 1236 or the 3D representation 1232 so that the 3D representation 1236 and the 3D representation 1232 may be aligned. The user may request that the 3D representation system move the 3D representation 1236 or the 3D representation 1232, such as by selecting the dashed line 1248 or by selecting the floor magnet tool 1214. Alternatively, the 3D representation system may move the 3D representation 1236 or the 3D representation 1232 once the user selects the second floor surface. FIG. 12P depicts that the 3D representation 1236 has moved such that the two selected floor surfaces are aligned and the 3D representation 1236 is aligned with the 3D representation 1232.

In some embodiments, a user may select other surfaces or structures to be used by the 3D representation system to align 3D representations. For example, the user may select non-planar surfaces or may select structures such as stairs. The 3D representation system may identify surfaces, structures, or other aspects of 3D representations and suggest that the user utilize such surfaces, structures, or other aspects to request movement or alignment of 3D representations.

The 3D representation system may also allow users to rotate 3D representations in order to position 3D representations. FIG. 12Q depicts the 3D representation 1236 selected in the region 1228 and the move element 1234 positioned proximate to the 3D representation 1236. The move element 1234 includes an arc 1262 between two arrows. The user may select the arc 1262 to enable rotation of the 3D representation 1236. The user may then select the 3D representation 1236 (for example, with an input device such as a mouse) and rotate the 3D representation 1236. FIG. 12R depicts the 3D representation 1236 rotated 32 degrees, as indicated by a rotation element 1250. The user may rotate the 3D representation 1236 any number of degrees clockwise or counterclockwise. In some embodiments, the 3D representation system may constrain rotation to certain degrees (for example, 45 degrees, 90 degrees, 1 degree, or 5 degrees).

For two 3D representations with overlapping structure, the user may use the wall magnet tool 1212 or the floor magnet tool 1214 to select unique surfaces or structures that are common to the two 3D representations and attempt to align them. Additionally or alternatively, the user may utilize the move tool 1210 to move the two 3D representations, such as by freely moving the two 3D representations, moving the two 3D representations along constrained axes, or by rotating the two 3D representations. The user may then utilize the auto align button 1220 to request that the 3D representation system automatically align the two 3D representations. The 3D representation system may then attempt to align the two 3D representations, such as by utilizing common mesh or structure. If there are one or more additional 3D representations to move or align, the user may lock the two 3D representations in place so that they may not be moved. The user may then move the one or more additional 3D representations to align the one or more additional 3D representations with the two 3D representations that are locked in place.

For two 3D representations without overlapping structure (or with barely overlapping structure), the wall magnet tool 1212 or the floor magnet tool 1214 may not be effective, as these tools may require common mesh or structure in order to move or align the two 3D representations. The user may use the move element 1234 to move the two 3D representations, such as by freely moving the two 3D representations, moving the two 3D representations along constrained axes, or by rotating the two 3D representations. When the user submits the two 3D representations for processing by selecting the merge models button 1222, the user may request that the 3D representations be locked so as to instruct the 3D representation system not to attempt to move or optimize the 3D representations relative to each other.

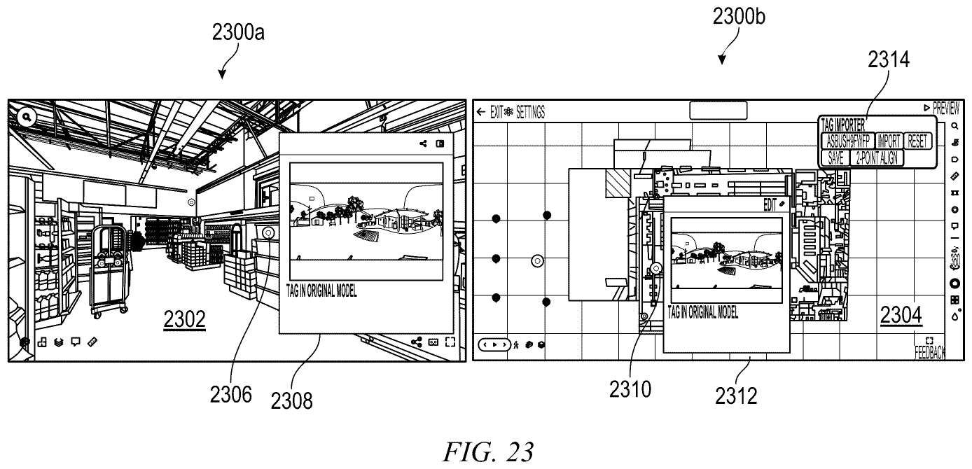

FIG. 12S depicts the interface 1200 after the user has selected the merge models button 1222. The interface 1200 displays an overlay 1264 in which the user may specify a name for the merged 3D representation and also specify several options for the merge. The user may specify that the 3D representation system is to blur faces of persons by selecting a blur faces toggle 1252. The user may also specify that the 3D representations be locked so as to instruct the 3D representation system not to attempt to move or optimize the 3D representations relative to each other by selecting a lock models toggle 1254. The user may also specify that annotations such as tags are to be copied from the 3D representations to be merged into the merged 3D representation by selecting a copy tags toggle 1256. Copying tags may be described in more detail with reference to, for example, FIG. 23. The user may select the button labeled “Merge Now” to request that the 3D representation system merge the 3D representations. FIG. 12T depicts the interface 1200 displaying an overlay 1258 indicating that the request to merge the 3D representations has been provided to the 3D representation system. The 3D representation system may merge the 3D representations and notify the user once the merge is complete and the 3D representation generated from merging the 3D representations may be accessed.

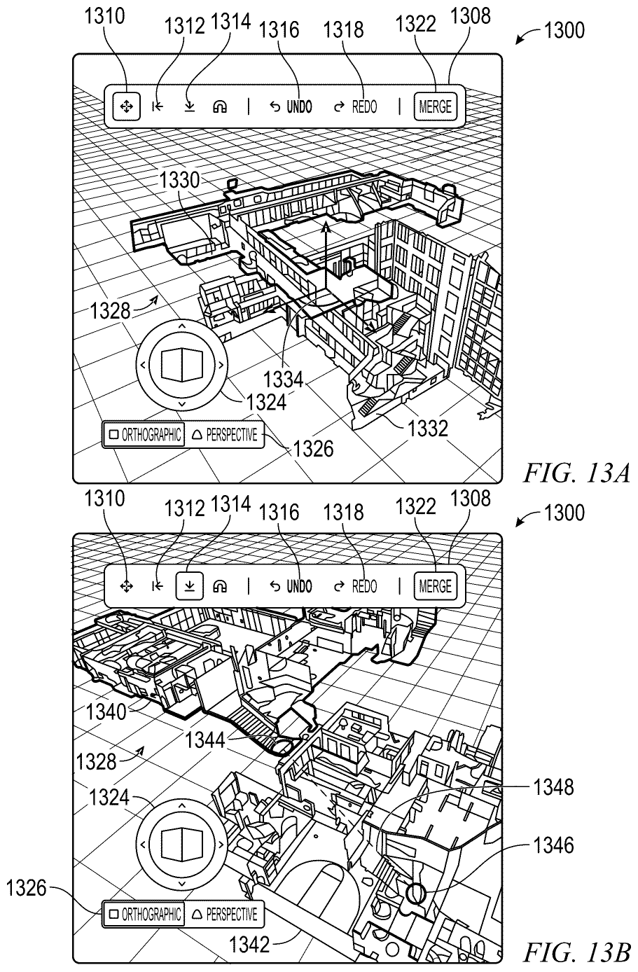

FIGS. 13A and 13B depict another example interface 1300 for combining 3D representations that may be provided by a 3D representation system in some embodiments. The interface 1300 may be provided by, for example, a presentation component 112 that is executing on a presentation system 110 that includes a mobile device. The interface 1300 includes a region 1328 for displaying 3D representations and a toolbar 1308 that includes a move tool 1310, a wall magnet tool 1312, a floor magnet tool 1314, an undo button 1316, a redo button 1318, and a merge button 1322. The interface 1300 also includes an orientation widget 1324 and a view selector 1326. In FIG. 13A, the region 1328 depicts a first 3D representation 1330 that is selected and that is proximate to a second 3D representation 1332. As the move tool 1310 is selected, a move element 1334 is displayed. In FIG. 13B, the user has selected the floor magnet tool 1314. The user has also selected a first floor surface (which is a stair landing) of a first 3D representation 1340 indicated by a first circle icon 1344 and a second floor surface (which is also a stair landing) of a second 3D representation 1342 indicated by a second circle icon 1346. There is a dashed line 1348 between the first circle icon 1344 and the second circle icon 1346. The functionality of the tools or elements depicted in FIGS. 13A and 13B may be at least generally similar to the tools or elements depicted in FIGS. 12A-12T.

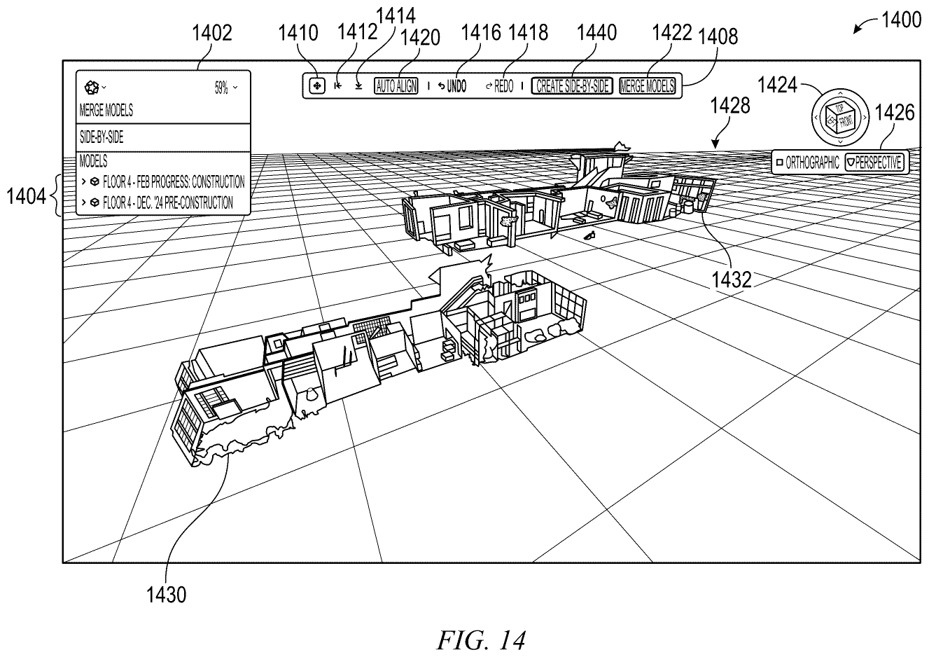

FIG. 14 depicts another example interface 1400 for combining 3D representations that may be provided by the 3D representation system according to some embodiments. The interface 1400 may be provided by, for example, a presentation component 112 that is executing on a presentation system 110 that includes a laptop or desktop computing device. The interface 1400 includes a region 1428 for displaying 3D representations and a toolbar 1408 that includes a move tool 1410, a wall magnet tool 1412, a floor magnet tool 1414, an undo button 1416, a redo button 1418, a merge button 1422, and a create side-by-side button 1440. The interface 1400 also includes an orientation widget 1424 and a view selector 1426. The interface 1400 also includes a 3D representation selector 1402 that displays names 1404 of 3D representations. The region 1428 displays a first 3D representation 1430 and a second 3D representation 1432.

A user may utilize the interface 1400 to create side-by-side comparisons of two or more 3D representations of the same environment over time or across different configurations. Examples may include documentation scans of a construction or renovation sequence to understand progress at different milestones, a commercial space configured in different designs so that potential customers can compare and contrast options, move-in or move-out comparisons for rented or leased properties, or comparing a virtual defurnished or virtually furnished version of a scanned space. The user may utilize the interface 1400 to move the two or more 3D representations so that the two or more 3D representations have a common coordinate system or are aligned.

To compare 3D representations with common surfaces and structural elements, the user may need to align the 3D representations together. The 3D representations may appear on top of each other as if occupying the same point in space in the region 1428. The user may use the wall magnet tool 1412 or the floor magnet tool 1414 to select unique surfaces or structures that are common to the two 3D representations and attempt to align them. Additionally or alternatively, the user may utilize the move tool 1410 to move the two 3D representations, such as by freely moving the two 3D representations, moving the two 3D representations along constrained axes, or by rotating the two 3D representations. The user may then utilize the auto align button 1420 to request that the 3D representation system automatically align the two 3D representations. The 3D representation system may then attempt to align the two 3D representations, such as by utilizing common mesh or structure. If there are one or more additional 3D representations to move or align, the user may lock the two 3D representations in place so that they may not be moved. The user may then move the one or more additional 3D representations to align the one or more additional 3D representations with the two 3D representations. In some embodiments, the 3D representation selector 1402 includes menu options that allow the user to switch between a light theme and a dark theme for the interface 1400. In some embodiments, the 3D representation selector 1402 includes a menu option that allows the user to provide a request to the 3D representation system to color the 3D representations. The 3D representation system may assign, based on the request, different colors to the 3D representations. The interface 1400 may then display in the region 1428 at least some of one 3D representation colored according to one color and at least some of another 3D representation colored according to another color. This may allow the user to see whether the 3D representations are well aligned. This may also allow the user to see differences between the 3D representations, such as furniture, more easily.

After aligning the 3D representations, the user may select the create side-by-side button 1440 to request that the 3D representation system combine the 3D representations by grouping the 3D representations. The 3D representation system may, based on the request, group the 3D representations, so that, for example, the 3D representations may be viewed simultaneously by a user.

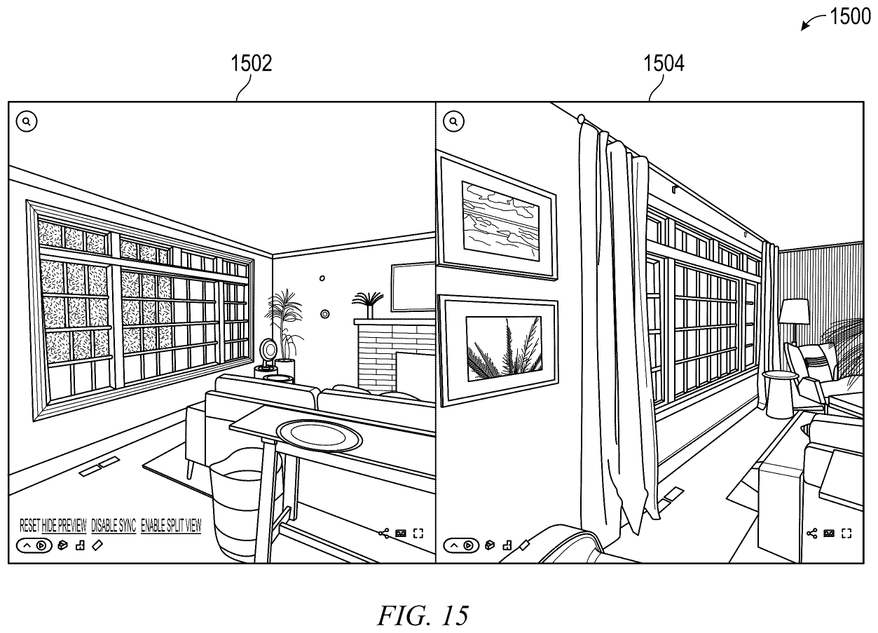

FIGS. 15-22 depict example interfaces for displaying combined 3D representations that may be provided by a 3D representation system in some embodiments. FIG. 15 depicts an example interface 1500 for displaying two combined 3D representations. The interface 1500 includes a first viewport 1502 and a second viewport 1504. The first viewport 1502 displays a first 3D representation and the second viewport 1504 displays a second 3D representation. A user may navigate or explore the two 3D representations. In some embodiments, the first viewport 1502 and the second viewport 1504 are synchronized, so that movement in either is reflected in the other. A first virtual camera may be used for the first viewport 1502 and a second virtual camera may be used for the second viewport 1504, and the views provided by the first virtual camera and the second virtual camera may be at least substantially similar in terms of virtual camera positioning and orientation in some embodiments. The user may request to unlink the two 3D representations, and the 3D representation system may unlink the two 3D representations so that the user may move independently in either 3D representation.

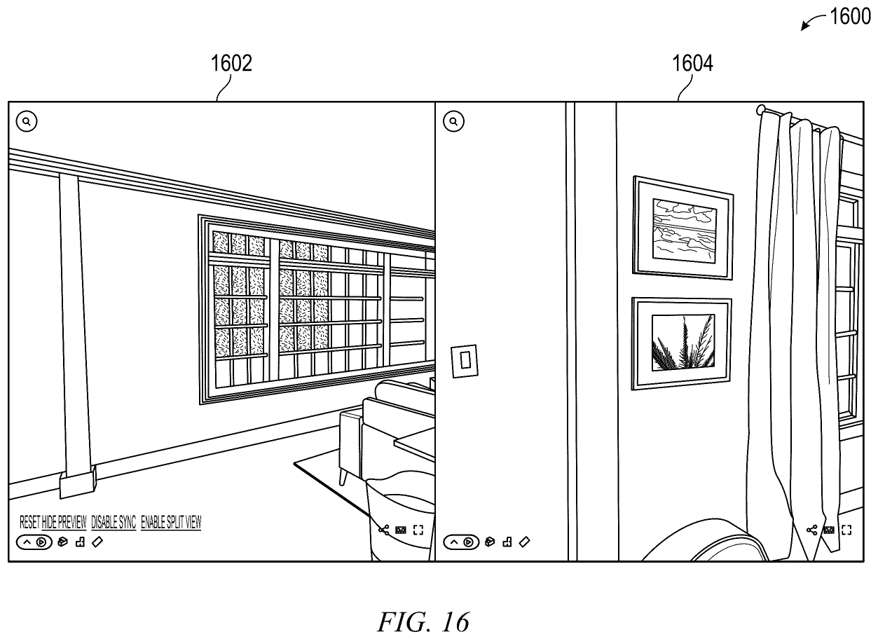

FIG. 16 depicts an interface 1600 for displaying a split view of two combined 3D representations. The interface 1600 includes a first viewport 1602 and a second viewport 1604. The first viewport 1602 and the second viewport 1604 may provide a split view of the two combined 3D representations. The first viewport 1602 may display a first 3D representation and the second viewport 1604 may display a second 3D representation. The first 3D representation and the second 3D representation may be displayed in the first viewport 1602 and the second viewport 1604 as if the portions of the first 3D representation proximate to the right edge of the first viewport 1602 transition smoothly to portions of the second 3D representation proximate to the left edge of the second viewport 1604. Similar to movement for the interface 1500, movement for the interface 1600 may be synchronized or may be unlinked so that the movement is not synchronized.

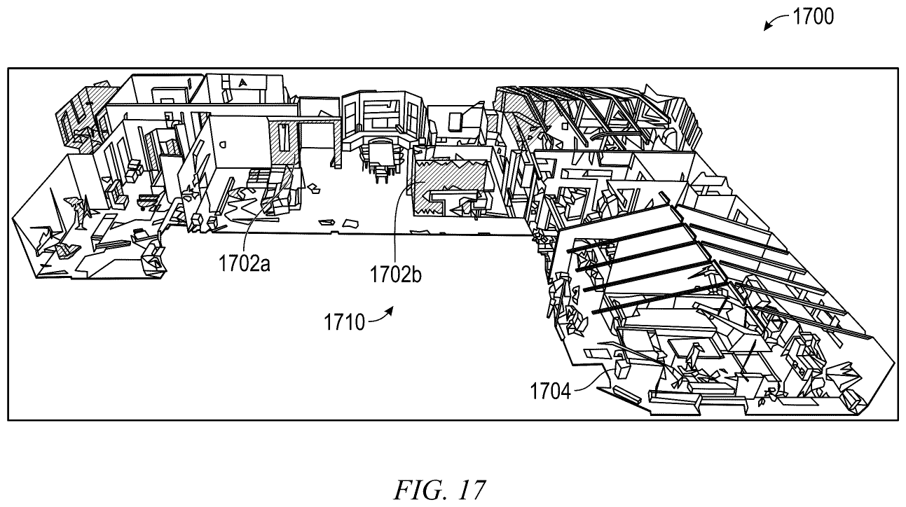

FIG. 17 depicts an interface 1700 that displays a heatmap 1710 that illustrates differences in mesh between two 3D representations. For example, the 3D representation system may depict portions of the heatmap 1710 according to one color to indicate that those portions have not changed between two 3D representations and other portions of the heatmap 1710 according to another color to indicate the extent to which those portions have changed between the two 3D representations. The heatmap 1710 depicts that a first wall surface 1702a and a second wall surface 1702b have both changed. The heatmap 1710 also depicts that furniture 1704 has changed. Heatmaps like the heatmap 1710 may thus illustrate changes in surfaces, structures, or furniture between two or more 3D representations.

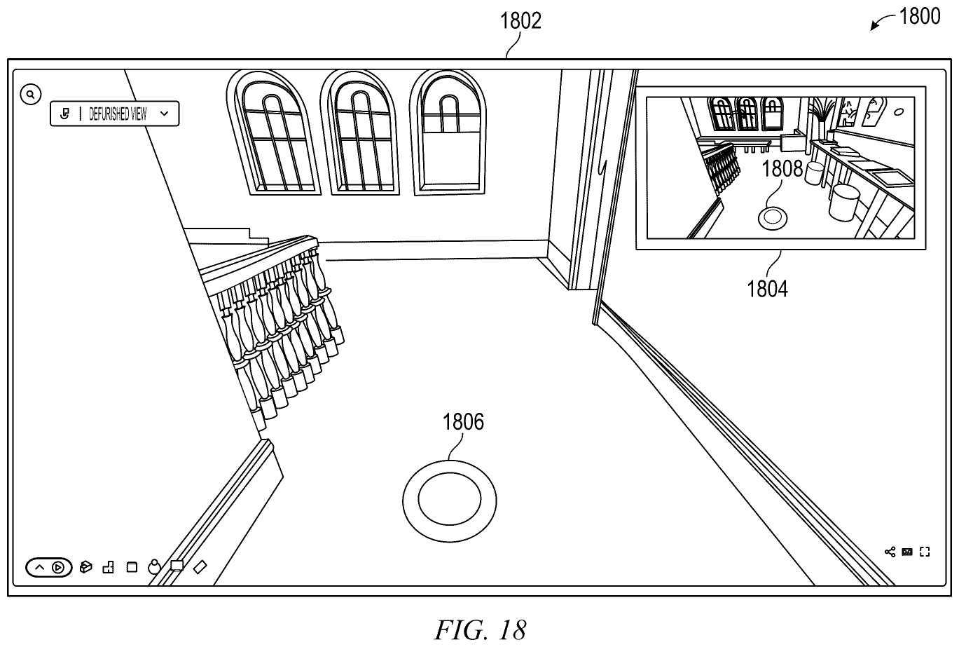

FIG. 18 depicts an interface 1800 for displaying a picture-in-picture view of two combined 3D representations. The interface 1800 includes a first viewport 1802 and a second viewport 1804 that is overlaid on the first viewport 1802. The first viewport 1802 displays a first 3D representation and the second viewport 1804 displays a second 3D representation. The first 3D representation includes a first circle 1806 for a first capture location and the second 3D representation includes a second circle 1808 for a second capture location that is positioned at generally the same location as the first circle 1806. The interface 1800 may allow a user to navigate the first 3D representation and have the movement be synchronized in the second 3D representation. The user may request to unlink the two 3D representations, and the 3D representation system may unlink the two 3D representations so that the user may move independently in either 3D representation.

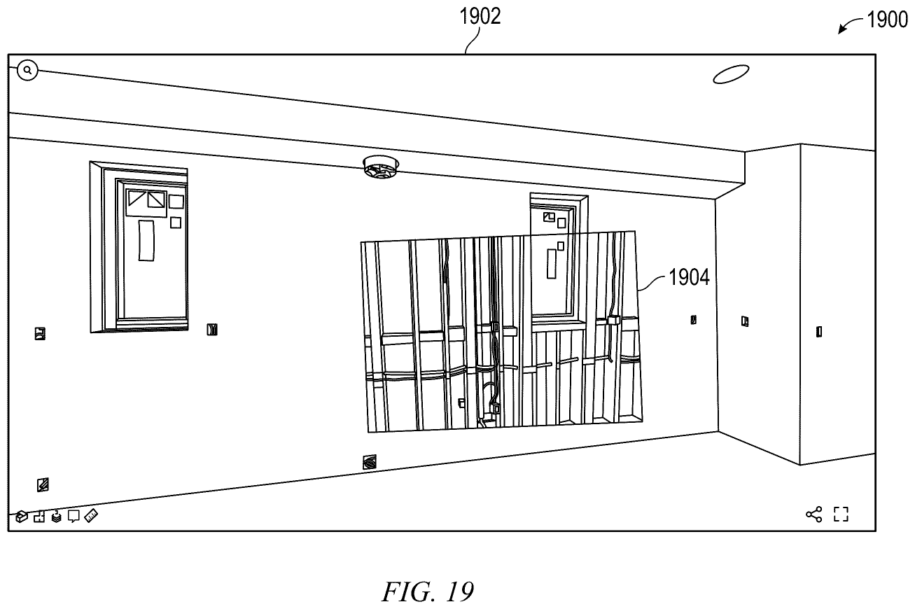

FIG. 19 depicts an interface 1900 for displaying an x-ray view of two combined 3D representations. The interface 1900 includes a first viewport 1902 and a second viewport 1904 that is overlaid on the first viewport 1902. The first viewport 1902 displays a first 3D representation and the second viewport 1904 displays a second 3D representation corresponding to the portion of the first 3D representation that the second viewport 1904 obscures. A user may provide inputs to resize or reposition the second viewport 1904 and the 3D representation system may resize or reposition the second viewport 1904 based on the inputs. The interface 1900 may allow a user to see the second 3D representation overlaid on the first 3D representation, which may be useful to see details of the second 3D representation, such as details captured during construction or remodeling of a building.

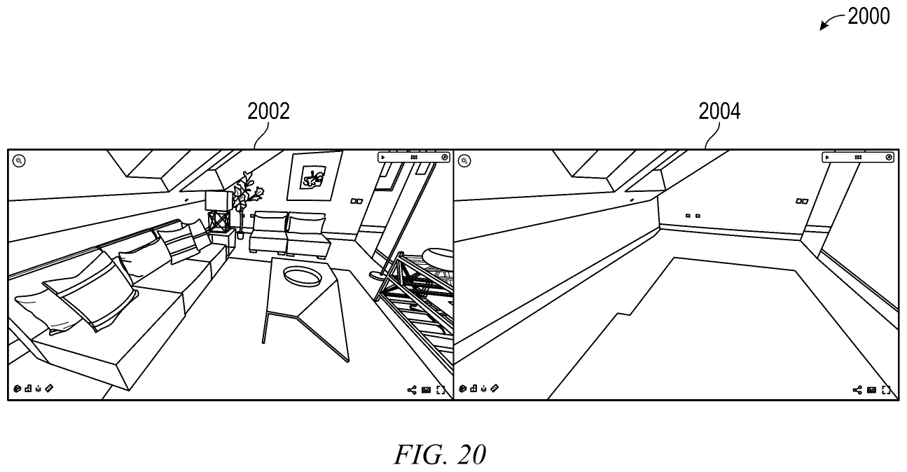

FIG. 20 depicts an interface 2000 for displaying two combined 3D representations. The interface 2000 includes a first viewport 2002 and a second viewport 2004. The first viewport 2002 may display a first 3D representation for an environment as the environment is furnished and the second viewport 2004 may display a second 3D representation for the environment showing the environment as unfurnished. The second 3D representation may have been generated through a defurnishing of the first 3D representation that removed furniture or other interior elements from the first 3D representation. The interface 2000 may allow a user to see the environment both as the environment is furnished and as the environment is unfurnished side-by-side. In some embodiments, the 3D representation system may provide the interface 2000 so as to allow the user to select the first 3D representation, have the first 3D representation displayed in the first viewport 2002, request that the first 3D representation be defurnished, and, after the 3D representation system has defurnished the first 3D representation, have the defurnished 3D representation displayed in the second viewport 2004.

In various embodiments, the 3D representation system may utilize the interface 2000 to allow a user to select a 3D representation for an unfurnished environment (for example, an unfurnished apartment or house) and have the 3D representation be displayed in the first viewport 2002. The 3D representation system may further allow the user to request that the 3D representation be furnished with furniture or other interior elements. The 3D representation system may furnish the 3D representation to generate a furnished 3D representation, and display the furnished 3D representation in the second viewport 2004. The user may navigate in the unfurnished 3D representation or the furnished 3D representation and a virtual camera for displaying the unfurnished 3D representation may be synchronized with a virtual camera for displaying the furnished 3D representation, so that movement of the user in either 3D representation may be synchronized. The user may be able to request that the two 3D representations be unlinked so that the movement is not synchronized.

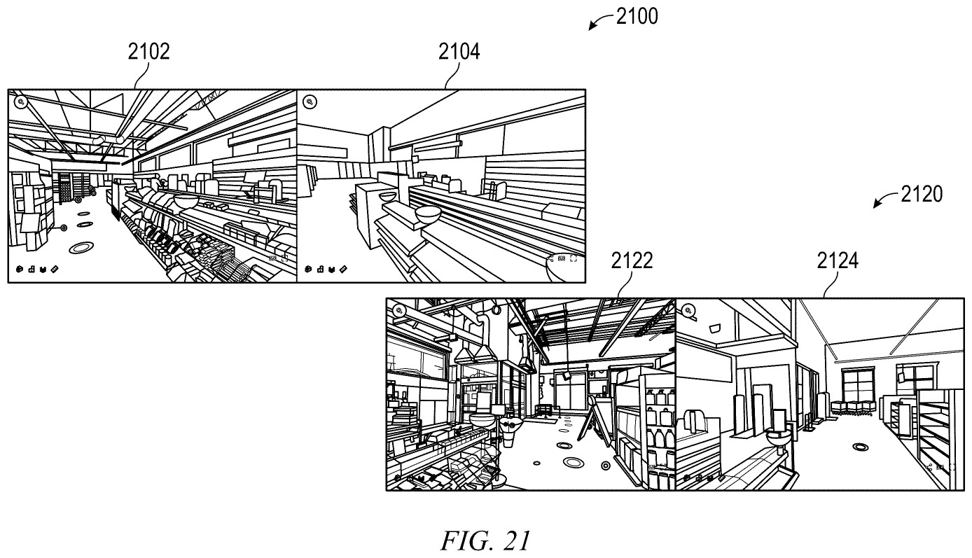

FIG. 21 depicts an interface 2100 and an interface 2120 for displaying two combined 3D representations. The interface 2100 includes a first viewport 2102 and a second viewport 2104. The first viewport 2102 may display a first 3D representation for an environment, which is a retail environment, and the second viewport 2104 may display a second 3D representation for the environment showing a potential redesign of the environment. Similarly, the interface 2120 includes a first viewport 2122 and a second viewport 2124. The first viewport 2122 may display a first 3D representation for an environment, which is a retail environment, and the second viewport 2124 may display a second 3D representation for the environment showing another potential redesign of the environment. The interface 2100 or the interface 2120 may allow users to see the environment both as the environment currently is configured and how the environment may be redesigned or reconfigured.

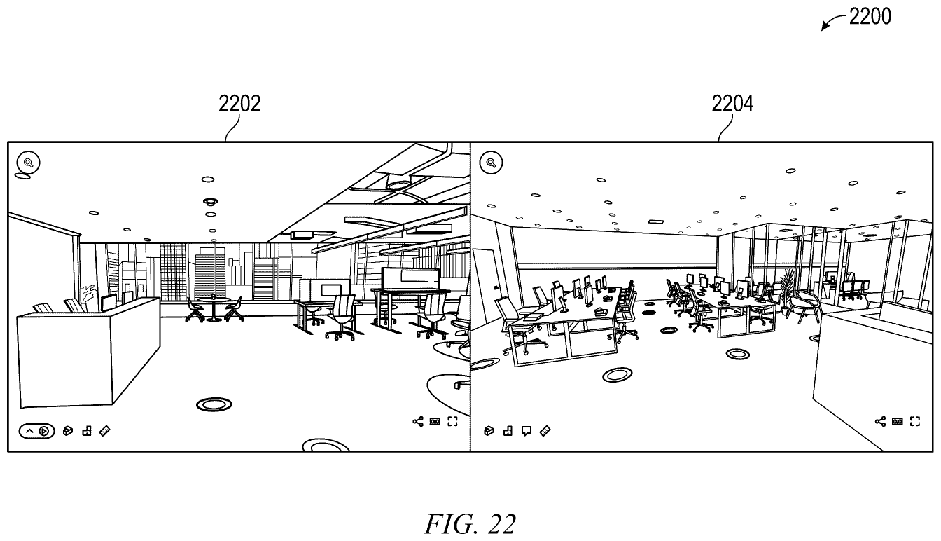

FIG. 22 depicts an interface 2200 for displaying two combined 3D representations. The interface 2200 includes a first viewport 2202 and a second viewport 2204. The first viewport 2202 may display a first 3D representation for an environment, which is an office environment, and the second viewport 2204 may display a second 3D representation for the environment showing a potential redesign of the environment. The interface 2200 may allow users to see the environment both as the environment currently is configured and how the environment may be redesigned or reconfigured.

### Annotations

A 3D representation may be generated from a merge of two or more 3D representations. One or both of the two or more 3D representations may have associated annotations, such as text, images, video, links to other 3D representations, or other content. The 3D representation system may associate the annotations with the 3D representation generated from the merge of the two or more 3D representations. For example, the 3D representation system may perform such association in response to a user request that is part of a merge request. As discussed herein, the interface 1200 may display an overlay 1264 that includes a copy tags toggle 1256 that the user may select to copy annotations from the 3D representations to be merged into the merged 3D representation. As another example, the 3D representation system may perform such association in response to a standalone user request (one that is not included in a merge request). Or, the 3D representation system may default to performing such association during a merge. As another example, the 3D representation system may provide a standalone plugin or tool for copying annotations from one or more 3D representations to one or more other 3D representations. Other approaches are possible.

FIG. 23 depicts an interface 2300a and an interface 2300b for associating an annotation of one 3D representation with another 3D representation that a 3D representation system according to some embodiments may implement. The interface 2300a depicts a 3D representation 2302 for a retail environment. The 3D representation 2302 may have an annotation associated with it, as indicated by a circular icon 2306. If a user selects the circular icon 2306, the interface 2300a may display an overlay 2308 that displays information about the annotation, which may include text, images, video, or other content. The interface 2300b displays another 3D representation 2304 for the retail environment. The 3D representation 2304 may be generated from a merge of the 3D representation 2302 and another 3D representation, or the 3D representation 2304 may be related in another way to the 3D representation 2302. For example, the 3D representation 2304 may be generated from data from a different capture session than the capture session that captured the data used to generate the 3D representation 2302. The 3D representation 2302 and the 3D representation 2304 may be related by the same location or other attributes.

The interface 2300b displays a toolbar 2314 that the user may use to copy annotations from the 3D representation 2302 to the 3D representation 2304. The user may select or specify annotations using the toolbar 2314 and request that the annotations be copied from the 3D representation 2302 to the 3D representation 2304. The interface 2300b displays that the annotation of the 3D representation 2302 has been copied to or otherwise associated with the 3D representation 2304. The 3D representation 2304 includes a circular icon 2310 that corresponds to the circular icon 2306 and is at generally the same location in the 3D representation 2304 that the circular icon 2306 is in the 3D representation 2302. Upon selection of the circular icon 2310, the interface 2300b displays an overlay 2312, which displays the same information about the annotation as displayed in the overlay 2308.

### Common Coordinate Systems

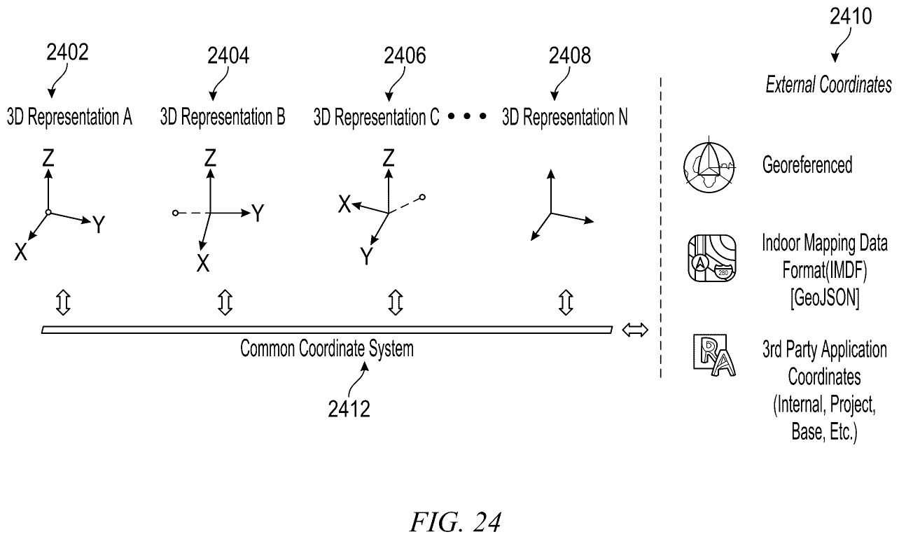

FIG. 24 illustrates that each 3D representation may have its own local coordinate system, and that the 3D representation system may maintain transforms between those local coordinate systems and a common coordinate system. As depicted, a first 3D representation A 2402, a second 3D representation B 2404, a third 3D representation C 2406, and an nth 3D representation N 2408 each have their own local coordinate system. In various embodiments, the local coordinate system for each 3D representation may be defined based on the first scan point acquired during the capture session and on a gravity vector derived from the capture device's inertial sensors. Because these local coordinate systems may differ across capture sessions or across different devices, the 3D representation system may store transforms between the 3D representations and a common coordinate system 2412.

In various embodiments, the 3D representation system may utilize the common coordinate system 2412 to implement or allow for use cases involving multiple versions of a structure or multiple 3D representations of different portions of an environment. For example, a building or jobsite may have several 3D representations captured at different times, by different devices, or by different teams, each resulting in coordinate systems that are not initially aligned. By storing transforms between each 3D representation and the common coordinate system 2412, the 3D representation system may allow these 3D representations to be related, aligned, or merged without losing the integrity of their original coordinate frames. This may also allow the 3D representation system to compare earlier and later versions of a 3D representation or to visualize changes over time throughout a structure.

In some embodiments, the 3D representation system may also store transforms that map a local coordinate system of a 3D representation to one or more external coordinate systems, such as the example external coordinate systems 2410 depicted in FIG. 24, that are outside the 3D representation itself. The external coordinate systems 2410 may include geolocated coordinate frames such as GPS, project-level coordinate systems from a third-party application, or site-specific coordinate systems used in construction or facilities management. Maintaining robust transforms between a 3D representation and the external coordinate systems 2410 may enable the 3D representation system to integrate 3D representations with other data sources or project management tools.

Additionally, the 3D representation system may maintain and update transforms when a 3D representation is edited, when a new version of a 3D representation is created, or when a user performs alignment operations between two or more 3D representations. Storing accurate transforms between the local coordinate system of a 3D representation and the common coordinate system 2412 ensures that all 3D representations, regardless of when or how they were created, can be placed into a consistent frame of reference. FIG. 24 therefore depicts how the 3D representation system may manage local coordinate systems and store transforms to ensure that a common coordinate system can be used for alignment, comparison, merging, viewing, and integration with external systems.

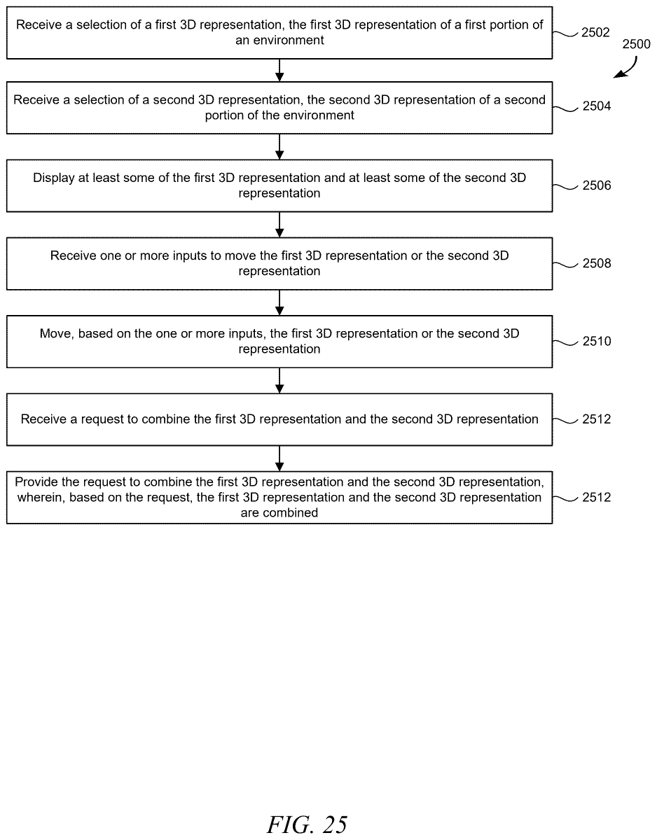

FIG. 25 is a flow diagram depicting a method 2500 for providing a request to combine two 3D representations that a 3D representation system according to some embodiments may implement. The 3D representation system (for example, the generation system 102) may perform the method 2500. At step 2502, the 3D representation system receives a selection of a first 3D representation, the first 3D representation of a first portion of an environment. At step 2504, the 3D representation system receives a selection of a second 3D representation, the second 3D representation of a second portion of the environment. At step 2506, the 3D representation system displays at least some of the first 3D representation and at least some of the second 3D representation. At step 2508, the 3D representation system receives one or more inputs to move the first 3D representation or the second 3D representation. At step 2510, the 3D representation system moves, based on the one or more inputs, the first 3D representation or the second 3D representation. At step 2512, the 3D representation system receives a request to combine the first 3D representation and the second 3D representation and provides the request to combine the first 3D representation and the second 3D representation. Based on the request, the 3D representation system combines the first 3D representation and the second 3D representation.

In some embodiments, the request to combine includes a request to merge the first 3D representation and the second 3D representation, and a third 3D representation is generated from merging the first 3D representation and the second 3D representation. The third 3D representation is of a third portion of the environment. In some embodiments, the first 3D representation includes a first portion and a second portion, and the third 3D representation is generated from the first portion and at least substantially all of the second 3D representation that replaces at least substantially all of the second portion. In various embodiments, the first 3D representation includes a first portion and a second portion, the second 3D representation includes a third portion and a fourth portion, and the third 3D representation is generated from the first portion, the third portion, and the second portion or the fourth portion. In some embodiments, there is substantially no overlap between the first 3D representation and the second 3D representation.

In various embodiments, the 3D representation system may receive a request to lock a first position of the first 3D representation and a second position of the second 3D representation, and provide the request to lock the first position and the second position. Based on the request, the first 3D representation and the second 3D representation are not moved relative to each other. In some embodiments, the first 3D representation and the second 3D representation are aligned, and the request to combine includes a request to group the first 3D representation and the second 3D representation. Based on the request, the first 3D representation and the second 3D representation are grouped. The 3D representation system may receive a request to align the first 3D representation and the second 3D representation and provide the request to align them. Based on the request, the first 3D representation and the second 3D representation are aligned. In some embodiments, the first 3D representation and the second 3D representation are aligned to a common coordinate system.

In some embodiments, receiving the one or more inputs to move the first 3D representation or the second 3D representation includes receiving a selection of a first surface of the first 3D representation and receiving a selection of a second surface of the second 3D representation. Moving the first 3D representation or the second 3D representation includes moving, based on the first surface and the second surface, the first 3D representation or the second 3D representation. The first surface and the second surface may each be a wall surface or the first surface and the second surface may each be a floor surface. In some embodiments, where a third 3D representation is generated from merging, the 3D representation system may receive a request to associate annotations of the first 3D representation or the second 3D representation with the third 3D representation and provide the request such that at least some annotations are associated with the third 3D representation.

In various embodiments, the 3D representation system may receive a request to color the first 3D representation and the second 3D representation, assign different colors to the first 3D representation and the second 3D representation, and display at least some of the first 3D representation colored according to the assigned color and at least some of the second 3D representation colored according to a different assigned color. In some embodiments, the 3D representations may originate from different devices or different capture sessions. For example, the first 3D representation may be generated from a first set of data captured by a first device in a first capture session and the second 3D representation may be generated from a second set of data captured by a second device in a second capture session.

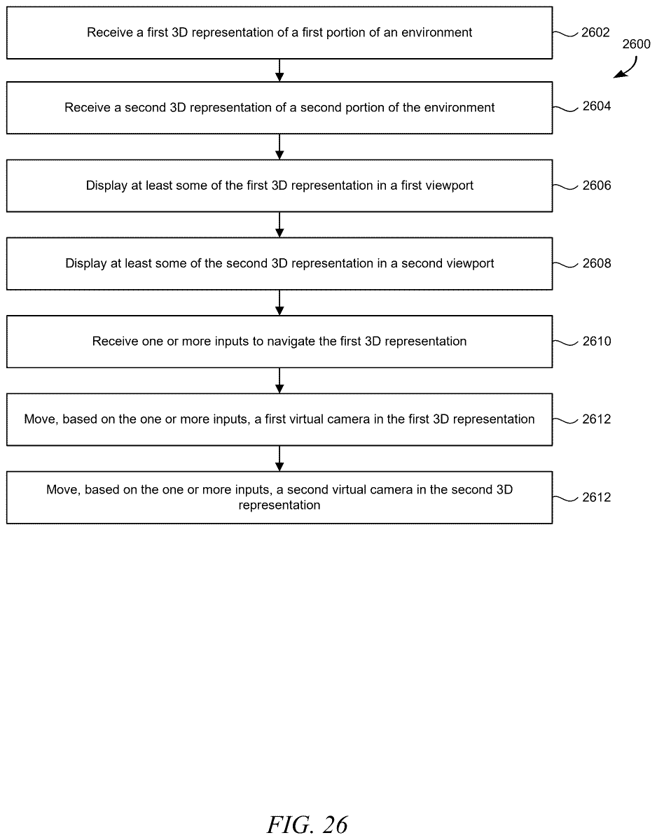

FIG. 26 is a flow diagram depicting a method 2600 for displaying combined 3D representations that a 3D representation system according to some embodiments may implement. The 3D representation system (for example, the generation system 102) may perform the method 2600. At step 2602, the 3D representation system receives a first 3D representation of a first portion of an environment. At step 2604, the 3D representation system receives a second 3D representation of a second portion of the environment. The first 3D representation and the second 3D representation are aligned to a common coordinate system based on a request to align the first 3D representation and the second 3D representation, and are grouped based on a request to combine the first 3D representation and the second 3D representation. At step 2606, the 3D representation system displays at least some of the first 3D representation in a first viewport. At step 2608, the 3D representation system displays at least some of the second 3D representation in a second viewport. At step 2610, the 3D representation system receives one or more inputs to navigate the first 3D representation. At step 2612, the 3D representation system moves, based on the one or more inputs, a first virtual camera in the first 3D representation, and moves, based on the one or more inputs, a second virtual camera in the second 3D representation.

In some embodiments, the first virtual camera is substantially synchronized with the second virtual camera, so that navigation inputs affecting the first 3D representation are mirrored in the second 3D representation. In various embodiments, a request to disable synchronization may be received, and, based on the request, synchronization may be disabled, allowing the first virtual camera and the second virtual camera to move independently. The first viewport and the second viewport may be adjacent and may provide a side-by-side view or a split view of the first and second 3D representations.

In some embodiments, the second viewport is overlaid on the first viewport while the second 3D representation is displayed. In various embodiments, displaying at least some of the second 3D representation in the second viewport may include displaying a second portion of the second 3D representation in place of a corresponding first portion of the first 3D representation within the overlaid region, thereby enabling localized comparisons while the remainder of the first 3D representation remains visible. The 3D representation system may receive second inputs to resize or reposition the second viewport, and, based on those inputs, resize or reposition the second viewport. In some embodiments, the second 3D representation includes a redesign of the first portion of the environment, enabling comparisons between an existing configuration and a redesigned configuration using synchronized or unsynchronized cameras across adjacent or overlaid viewports.

The 3D representation system may significantly enhance property marketing by enabling sellers, agents, and marketing platforms to present a unified, comprehensive digital view of a property. Detached garages, outbuildings, guest houses, ADUs, garden structures, and extensive landscaping can be captured in separate sessions and then merged into a single 3D representation, allowing prospective buyers to explore the entire property as one seamless environment. Rather than forcing users to open separate digital models or navigate disjointed links, the 3D representation system may position and align all portions relative to a common coordinate system, so the buyer may experience the property, from the home's interior to exterior amenities, in one continuous, intuitive digital walkthrough.

In various embodiments, real-estate professionals may leverage these capabilities to create rich marketing experiences that would otherwise not be possible. For example, luxury listings with multiple wings, pools, patios, barns, sport courts, or private trails may be digitized in sections using different teams or at different times and then combined, so that buyers can meaningfully assess property scale and connectivity. Commercial listings, such as multi-building office parks, distribution centers, storage facilities, or industrial sites, may similarly be marketed as unified 3D representations, enabling tenants or investors to understand operational adjacencies, access points, loading areas, and circulation paths without needing multiple disjointed files or in-person site visits.

The 3D representation system may also support ongoing listing accuracy by allowing real-estate professionals to update only those portions of a property that have changed, such as renovated kitchens, new landscaping, or refreshed staging. Because the 3D representation system can merge partial scans into an existing 3D representation while automatically aligning the updated areas to a stable coordinate system, agents may keep their listings current without re-scanning the entire property. This enables more efficient marketing workflows and provides prospective buyers with up-to-date representations that reflect current finishes, improvements, or seasonal conditions.

In addition, property-management companies, leasing offices, and builders may use updated digital twins to support pre-sale and pre-lease marketing. For example, a builder may merge design-stage models, construction-progress scans, and final as-built captures to show buyers how a property has evolved over time or how a finished home will relate to nearby structures. Leasing offices may use grouped or merged representations to enable prospective residents to compare multiple units, which may be vacant, staged, renovated, or redesigned, within a single interactive interface. This allows them to navigate between unit types or view a unit's earlier and later configurations (for example, pre-renovation vs. post-renovation) without switching tools or digital files.

The 3D representation system may also support broader real-estate ecosystem workflows, including appraisal, inspection, and pre-closing activities. Inspectors may merge scans taken at different times to identify structural or maintenance changes. Appraisers may group separated buildings on a parcel to contextualize measurements and relationships. Real-estate marketers may embed grouped or merged digital twins in property-listing websites to differentiate offerings with immersive, spatially accurate, visually unified content. These capabilities allow the real-estate industry to deliver more engaging, informative, and trustworthy digital property experiences, improving decision-making for buyers, tenants, and stakeholders while reducing the friction traditionally associated with multi-model property documentation.

The claimed techniques improve computer performance by transforming how independently generated 3D data is aligned, combined, updated, and displayed. For example, the 3D representation system may accept selections of multiple 3D representations, display them together, accept inputs to move them, and then combine them in response to a user request. This process operationalizes specific computer-implemented manipulations of meshes, scan points, and transforms that reduce redundant data handling and avoid whole-model reprocessing. The disclosure explains resource-aware merging that manages voxel budgets and preserves mesh fidelity, which are concrete optimizations that reduce compute, memory, and bandwidth otherwise required to rebuild or duplicate large models. These optimizations are implemented by the 3D representation system and directly improve computational efficiency over conventional pipelines that force full rescans or manual, error-prone recompositions.

Moreover, aspects are generally directed toward aligning multiple 3D representations, including versions produced by different devices or sessions, and storing transforms to a common coordinate system and, where applicable, to external coordinate frames such as GPS or project coordinates. Each 3D representation may have a local coordinate system (first scan point plus gravity vector), and the 3D representation system may maintain and update transforms across edits, new versions, and merges. Persisting accurate transforms enables deterministic, repeatable alignment across time, prevents drift between versions, and reduces costly re-registration operations. These capabilities improve the functioning of a computer's 3D pipeline itself by providing new data structures and processes that stabilize spatial relationships across heterogeneous inputs and versions.

Interface mechanisms, such as wall and floor “magnet” tools, lockable positions, and auto-align, invoke and parameterize underlying alignment and transform computations that re-pose and constrain large meshes along structural surfaces. The 3D representation system also enables synchronized or de-synchronized virtual cameras across multiple viewports, adjacent/split and overlay (picture-in-picture/x-ray) layouts, and localized replacement of one portion with another within an overlay. These features may produce deterministic camera and scene-graph behaviors (for example, coupled camera matrices and viewport transforms), enabling coordinated multi-model navigation and comparison that conventional viewers cannot perform without ad hoc exports and manual compositing. By altering how the rendering pipeline manages multiple scenes and cameras, these techniques improve a computer's display and navigation subsystems in concrete, technical ways.

The 3D representation system supports partial updates that integrate newly captured data directly into an existing 3D representation while preserving annotations through mapping or transfer. This avoids duplicative project copies and manual deletions and eliminates full-scene recomputation, thereby reducing processing time and input/output. Further, the heat-mesh generation compares mesh elements across versions, producing computed, color-encoded difference fields that drive inspection and analysis, not merely visualization. These are new computer-implemented processes that enable efficient maintenance of complex 3D assets with continuity of metadata, improving the broader technical field of 3D capture, reconstruction, and visualization by providing scalable versioning, change detection, and annotation persistence that traditional systems lack.

The 3D representation system allows for grouping and coordinated navigation across physically separated or partially overlapping 3D representations (for example, multi-unit complexes or campuses), with alignment to a shared coordinate frame, link-based transitions, and group-aware transforms. These mechanisms enable a computer system to compose very large or fragmented datasets into operational, navigable collections without flattening them into a single monolith, thereby improving scalability, responsiveness, and maintainability. The resulting capability, which may enable seamlessly moving among related models with stable spatial context, constitutes a technical advance in 3D systems that overcomes the performance and workflow constraints of legacy per-model viewers and ad hoc hyperlinking.

Aspects of the disclosure change how computers acquire, align, combine, render, and maintain 3D data. Such aspects introduce specific data structures (stored transforms), synchronization behaviors (dual virtual cameras), alignment/composition operations (surface-guided movement, lock/auto-align), and resource-aware merging that improve the functioning of the computer and advance the technical field of 3D representation systems beyond generic data processing or abstract idea implementations.

FIG. 27 depicts a block diagram of an example digital device 2700 according to some embodiments. The digital device 2700 is shown in the form of a general-purpose computing device. The digital device 2700 includes at least one processor 2702, which may be or include one or more central processing units (CPUs) or one or more graphics processing units (GPUs), random access memory (RAM 2704), a communication interface 2706, an input/output device 2708, storage 2710, and a system bus 2712 that couples various system components, including storage 2710, to the at least one processor 2702. A set (which may be a physical set or a logical set) of one or more of the digital device 2700 may be referred to as a computing system.

System bus 2712 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 2700 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 2702 is configured to execute executable instructions (for example, programs). In some embodiments, the at least one processor 2702 comprises circuitry or any processor capable of processing the executable instructions.

In some embodiments, RAM 2704 stores programs or data. In various embodiments, working data is stored within RAM 2704. The data within RAM 2704 may be cleared or ultimately transferred to storage 2710, such as prior to reset or powering down the digital device 2700.

In some embodiments, the digital device 2700 is coupled to a network via communication interface 2706. The digital device 2700 can communicate with one or more networks, such as a local area network (LAN), a general wide area network (WAN), or a public network (for example, the Internet).

In some embodiments, input/output device 2708 is any device that inputs data (for example, mouse, keyboard, stylus, sensors, etc.) or outputs data (for example, speaker, display, virtual reality headset).

In some embodiments, storage 2710 can include computer system readable media in the form of non-volatile memory, such as read-only memory (ROM), programmable read-only memory (PROM), solid-state drives (SSD), flash memory, or cache memory. Storage 2710 may further include other removable/non-removable, volatile/non-volatile computer system storage media. By way of example only, storage 2710 can be provided for reading from and writing to a non-removable, non-volatile magnetic media. The storage 2710 may include a non-transitory computer-readable medium, or multiple non-transitory computer-readable media, which store programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk, such as a CDROM, DVD-ROM, or other optical media, can be provided. In such instances, each can be connected to system bus 2712 by one or more data media interfaces. As will be further depicted and described below, storage 2710 may include at least one program product having a set (for example, at least one) of program modules that are configured to carry out the functions of embodiments of the technology. In some embodiments, RAM 2704 is found within storage 2710.

Programs/utilities, having a set (at least one) of program modules, may be stored in storage 2710, by way of example, and not limitation, as well as an operating system, one or more application programs, other program modules, and program data. Each of the operating system, one or more application programs, other program modules, and program data, or some combination thereof, may include an implementation of a networking environment. Program modules generally carry out the functions or methodologies of embodiments of the technology as described herein.

It should be understood that, although not shown, other hardware or software components could be used in conjunction with the digital device 2700. Examples include, but are not limited to, microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module, or system. Furthermore, aspects may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), a solid-state drive (SSD), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program or data for use by or in connection with an instruction execution system, apparatus, or device.

A transitory computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further, any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. For example, the 3D representation system may implement a lightweight merge pipeline that runs entirely on a user device with intermittent connectivity, deferring heavy optimization to a later cloud pass when a network is available. As another example, the 3D representation system may assign per-surface (or per-region) confidence scores during alignment and allow atomic rollback of only low-confidence regions after a merge, without discarding high-confidence portions. As another example, the 3D representation system may apply role-based permissions and immutable audit logs at the group level so different collaborators can view, annotate, or merge subsets of grouped 3D representations with tracked provenance of edits and transforms. As yet another example, the 3D representation system may deliver merged or grouped results via progressive LOD tiles or proxy meshes for instant preview, promoting higher-fidelity assets in the background as bandwidth and device resources permit. Therefore, these and other variations upon the example embodiments are intended to be covered by the disclosure herein.

1. A method performed by one or more computing systems that include one or more processors and memory, the method comprising:
receiving a selection of a first 3D representation, the first 3D representation of a first portion of an environment;
receiving a selection of a second 3D representation, the second 3D representation of a second portion of the environment;
displaying at least some of the first 3D representation and at least some of the second 3D representation;
receiving one or more inputs to move the first 3D representation or the second 3D representation;
moving, based on the one or more inputs, the first 3D representation or the second 3D representation;
receiving a request to combine the first 3D representation and the second 3D representation; and
providing the request to combine the first 3D representation and the second 3D representation,
wherein, based on the request, the first 3D representation and the second 3D representation are combined.

2. The method of claim 1 wherein the request to combine the first 3D representation and the second 3D representation includes a request to merge the first 3D representation and the second 3D representation, and wherein a third 3D representation is generated from merging the first 3D representation and the second 3D representation, the third 3D representation of a third portion of the environment.

3. The method of claim 2 wherein the first 3D representation includes a first portion and a second portion, the third 3D representation is generated from the first portion and at least substantially all of the second 3D representation that replaces at least substantially all of the second portion.

4. The method of claim 2 wherein the first 3D representation includes a first portion and a second portion, the second 3D representation includes a third portion and a fourth portion, and the third 3D representation is generated from the first portion, the third portion, and the second portion or the fourth portion.

5. The method of claim 2 wherein there is substantially no overlap between the first 3D representation and the second 3D representation.

6. The method of claim 2, further comprising:
receiving a request to lock a first position of the first 3D representation and a second position of the second 3D representation; and
providing the request to lock the first position and the second position,
wherein, based on the request, the first 3D representation and the second 3D representation are not moved relative to each other.

7. The method of claim 1 wherein the first 3D representation and the second 3D representation are aligned, the request to combine the first 3D representation and the second 3D representation includes a request to group the first 3D representation and the second 3D representation, and based on the request, the first 3D representation and the second 3D representation are grouped.

8. The method of claim 7, further comprising:
receiving a request to align the first 3D representation and the second 3D representation; and
providing the request to align the first 3D representation and the second 3D representation;
wherein, based on the request, the first 3D representation and the second 3D representation are aligned.

9. The method of claim 7 wherein the first 3D representation and the second 3D representation are aligned to a common coordinate system.

10. The method of claim 1 wherein receiving the one or more inputs to move the first 3D representation or the second 3D representation includes:
receiving a selection of a first surface of the first 3D representation; and
receiving a selection of a second surface of the second 3D representation,
wherein moving the first 3D representation or the second 3D representation includes moving, based on the first surface and the second surface, the first 3D representation or the second 3D representation.

11. The method of claim 10 wherein each of the first surface and the second surface includes a wall surface or each of the first surface and the second surface includes a floor surface.

12. The method of claim 1 wherein a third 3D representation is generated from merging the first 3D representation and the second 3D representation, the third 3D representation of a third portion of the environment, and further comprising:
receiving a request to associate first annotations of the first 3D representation or second annotations of the second 3D representation with the third 3D representation; and
providing the request to associate the first annotations or the second annotations with the third 3D representation,
wherein, based on the request, at least some of the first annotations or at least some of the second annotations are associated with the third 3D representation.

13. The method of claim 1, further comprising:
receiving a request to color the first 3D representation and the second 3D representation;
assigning, based on the request, a first color to the first 3D representation and a second color to the second 3D representation; and
displaying at least some of the first 3D representation colored according to the first color and at least some of the second 3D representation colored according to the second color.

14. The method of claim 1 wherein the first 3D representation is generated from a first set of data captured by a first device in a first capture session and the second 3D representation is generated from a second set of data captured by a second device in a second capture session, the first device different from the second device or the first capture session different from the second capture session.

15. A non-transitory computer-readable medium comprising executable instructions, the executable instructions being executable by one or more processors to perform a method, the method comprising:
receiving a selection of a first 3D representation, the first 3D representation of a first portion of an environment;
receiving a selection of a second 3D representation, the second 3D representation of a second portion of the environment;
displaying at least some of the first 3D representation and at least some of the second 3D representation;
receiving one or more inputs to move the first 3D representation or the second 3D representation;
moving, based on the one or more inputs, the first 3D representation or the second 3D representation;
receiving a request to combine the first 3D representation and the second 3D representation; and
providing the request to combine the first 3D representation and the second 3D representation,
wherein, based on the request, the first 3D representation and the second 3D representation are combined.

16. The non-transitory computer-readable medium of claim 15 wherein the request to combine the first 3D representation and the second 3D representation includes a request to merge the first 3D representation and the second 3D representation, and wherein a third 3D representation is generated from merging the first 3D representation and the second 3D representation, the third 3D representation of a third portion of the environment.

17. The non-transitory computer-readable medium of claim 16 wherein the first 3D representation includes a first portion and a second portion, the third 3D representation is generated from the first portion and at least substantially all of the second 3D representation that replaces at least substantially all of the second portion.

18. The non-transitory computer-readable medium of claim 16 wherein the first 3D representation includes a first portion and a second portion, the second 3D representation includes a third portion and a fourth portion, and the third 3D representation is generated from the first portion, the third portion, and at least substantially all of the fourth portion that replaces at least substantially all of the second portion.

19. The non-transitory computer-readable medium of claim 16 wherein there is substantially no overlap between the first 3D representation and the second 3D representation.

20.-28. (canceled)

29. A system comprising at least one processor and at least one memory including
executable instructions that, when executed by the at least one processor, cause the system to:
receive a selection of a first 3D representation, the first 3D representation of a first portion of an environment;
receive a selection of a second 3D representation, the second 3D representation of a second portion of the environment;
display at least some of the first 3D representation and at least some of the second 3D representation;
receive one or more inputs to move the first 3D representation or the second 3D representation;
move, based on the one or more inputs, the first 3D representation or the second 3D representation;
receive a request to combine the first 3D representation and the second 3D representation; and
provide the request to combine the first 3D representation and the second 3D representation,
wherein, based on the request, the first 3D representation and the second 3D representation are combined.

30.-50. (canceled)
